(19) United States
(12) Patent Application Publication
(10) Pub. No.: US 2019/0097968 A1
(43) Pub. Date: Mar. 28, 2019

(54) SCIP AND IPSEC OVER NAT/PAT ROUTERS

(71) Applicants: Sarah K. Inforzato, Malvern, PA (US); Gregory J. Small, Malvern, PA (US); Robert A. Johnson, Malvern, PA (US); Barry C. Andersen, Roseville, MN (US); Kathleen Wild, Malvern, PA (US)

(72) Inventors: Sarah K. Inforzato, Malvern, PA (US); Gregory J. Small, Malvern, PA (US); Robert A. Johnson, Malvern, PA (US); Barry C. Andersen, Roseville, MN (US); Kathleen Wild, Malvern, PA (US)

(73) Assignee: Unisys Corporation, Blue Bell, PA (US)

(21) Appl. No.: 15/718,533

(22) Filed: Sep. 28, 2017

(51) Int. Cl. H04L 29/12; H04L 12/741; H04L 29/06

(52) U.S. Cl. CPC H04L 61/2592; H04L 45/745; H04L 45/72; H04L 63/0428; H04L 61/256

(57) ABSTRACT

A method of communicatively connecting first and second endpoints across a NAT and/or PAT router to form an IPSec encrypted tunnel is disclosed. A message is received by the first endpoint from the second endpoint. The message includes an encrypted portion including a source port, a destination port, a source IP address, and a destination IP address. It is determined whether a table entry exists for the message. If Yes, it is determined by the first endpoint whether a NAT router and/or a PAT router is between the first endpoint and the second endpoint based, at least in part, on the table entry and the encrypted portion of the message. If Yes, an IPSec encrypted tunnel is created using IPSec transport mode for further communications between the first and second endpoints. An apparatus and a computer program product are also disclosed.

### FIELD OF THE DISCLOSURE

The present application relates generally to secured communications and storage system, and in particular to secured network; including NAT and/or PAT routers between endpoints applying internet protocol security.

### BACKGROUND

Modern organizations generate store, and communicate large quantities of data. In many instances, organizations include individuals having different rights to data, or different rights to communicate with other individuals or access particular computing resources. It is frequently important that such organizations be able to quickly and securely access the data stored at the data storage system. In addition, it is frequently important that data stored at a data storage system, or communicated between computing systems, be recoverable if the data is communicated or written incorrectly or are otherwise intercepted or corrupted. To address these and other issues, Unisys Corporation of Blue Bell, Pa., developed Unisys Stealth® Software, also referred to as “Stealth,” that implements end-to-end cryptographic connections for communication of data across public and private networks. This solution allows users to communicate with other users having common user rights, while segregating user groups by way of assignment of different cryptographic keys used (or each user group, or “community of interest.”

### SUMMARY

Unisys Stealth® Software currently does not support Network Address translation (“NAT”) or Port Address Translation (“PAT”) traversal. There is, therefore, a need to support the Stealth protocol (SCIP and IPsec) in networks with NAT 1:1 routers and/or PAT routers (“NAT/PAT routers”). In accordance with embodiments of the invention, changes are made to the SCIP protocol to support NAT traversal, and changes are made to the endpoint software to support IPsec with NAT traversal. In examples of embodiments of the invention, the exchange of messages, such as the S0, S1, and S2 SCIP PDUs across a NAT router 112 and/or PAT router 118 (“NAT/PAT router”) establishes a Stealth tunnel and allows each endpoint to determine its own position in the Stealth connection/tunnel i.e., to determine if it is behind a NAT 1:1 router or a PAT router, and to determine if the other endpoint is legacy endpoint or a NAT/PAT endpoint. Within the message exchange, the sending side provides the information, and the receiving side uses the information to determine its position as well as the remote endpoints position relative to itself. Unisys Stealth® Software as described herein, which is also referred to as SCIP version 2, is also available from Unisys Corporation of Blue Bell, Pa.

In a first aspect, a method of communicatively connecting a first endpoint to a second endpoint to form an IPSec encrypt tunnel is disclosed, wherein at least one of the endpoints is behind a PAT or NAT router. The method comprises receiving a message by the first endpoint from the second endpoint, the message including an encrypted portion including a source port, a destination port, a source IP address, and a destination IP address, and determining whether a table entry exists for the message. If the table entry exists, the method comprises determining by the first endpoint whether a NAT router and/or a PAT router is between the first endpoint and the second endpoint based, at least in part, on the table entry and the encrypted portion of the message. The method further comprises creating an IPSec encrypted tunnel using IPSec transport mode for further communications between the first endpoint and the second endpoint, if a NAT router and/or a PAT router is determined to be between the first endpoint and the second endpoint.

In a second aspect, an apparatus comprises a memory and a processor coupled to the memory. The processor is configured to perform the step of receiving a message by the first endpoint from the second endpoint, the message including an encrypted portion including a source port, a destination port, a source IP address, and a destination IP address. The processor is further configured to perform the steps of determining whether a table entry exists for the message, and if the table entry exists, determining by the first endpoint whether a NAT router and/or a PAT router is between the first endpoint and the second endpoint based, at least in part, on the table entry and the encrypted portion of the message. The processor is further configured to perform the step of creating an IPSec encrypted tunnel using IPSec transport mode for further communications between the first endpoint and the second endpoint, if a NAT router and/or a PAT router is determined to be between the firs; endpoint and the second endpoint.

In a third aspect, a computer program product is disclosed comprising a non-transitory computer readable medium comprising instructions which, when executed by a processor of a computer system, cause the processor to perform the steps of receiving a message by the first endpoint from the second endpoint, the message including an encrypted portion including a source port, a destination port, a source IP address, and a destination IP address, and determining whether a table entry exists for the message. The computer readable medium further comprises instructions which cause the processor to perform the steps of, if the table entry exists, determining by the first endpoint whether a NAT router and/or a PAT router is between the first endpoint and the second endpoint based, at least in part, on the table entry and the encrypted portion of the message; and creating an IPSec encrypted tunnel using IPSec transport mode for further communications between the first endpoint and the second endpoint if a NAT router and/or a PAT router is determined to be between the first endpoint and the second endpoint.

In other aspects, backward compatibility is supported to allow an endpoint running the updated Unisys Stealth® Software, SCIP version 2, to properly identify an endpoint running the non-updated SCIP such as SCIP version 1, which may not use the SCIP port as the support port for all SCIP PDUs.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the disclosed system and methods, reference is not made to the following descriptions taken in conjunction with the accompanying drawings.

FIG. 1 is a schematic diagram of an example of a NAT/PAT network configuration in which embodiments of the invention may be practiced;

FIG. 2 is a flow chart of an example of tunnel initiation and table entry creation in accordance with an embodiment of the invention;

FIG. 3 is a How chart of an example of a process for determining whether a PAT and/or NAT router is present using a NAT Option, in accordance with an embodiment of the invention;

FIG. 4 is flow diagram of an example of tunnel initiation from a legacy device to non-legacy device, in accordance with an embodiment of invention;

FIG. 5 is a flow diagram of an example of tunnel initiation from a non-legacy device to a legacy device, in accordance with an embodiment of the invention;

FIG. 6 is a flow diagram of an example of PAT endpoint to non-legacy tunnel initiation, in accordance with an embodiment of the invention;

FIG. 7 is a flow diagram of the example of FIG. 6, showing tunnel/table entries, in accordance with an embodiment of the invention;

FIG. 8 is an example of SCIP IDLE exchange, in accordance with an embodiment of the invention;

FIG. 9 is an example of SCIP Keep Alive exchange, in accordance with an embodiment of the invention;

FIG. 10A and FIG. 10B are flow diagrams of an example of SCIP exchange initiated from a PAT endpoint to an endpoint behind a NAT router, in accordance with an embodiment of the invention; and

FIG. 11 is a block diagram of an example of a processing device, such as a server or a client, that may be used in the computer network of FIG. 1.

### DETAILED DESCRIPTION

In accordance with embodiments of the invention, Network Address Translation (“NAT”) router traversal and/or Port Address Translation (“PAT”) router traversal via Stealth tunnels are enabled. In some embodiments, changes are made to the SCIP protocol to support NAT and/or PAT (“NAT/PAT”) traversal and changes are made to the endpoint software to support IPsec with NAT/PAT traversal. Examples of implementations of embodiments of the invention include initiation of Stealth tunnels: 1) from a NAT/PAT endpoint to a global (public) endpoint; 2) from a global endpoint to a NAT endpoint using the public address of the NAT endpoint; 3) from a PAT endpoint to a NAT endpoint using the public address of the NAT endpoint; and/or 4) from a NAT endpoint to a NAT endpoint using the public address of the NAT endpoint. In the following description, “from” and “to” are indicative of establishing a Stealth tunnel between endpoints but the secure traffic is bidirectional.

Descriptions of versions of Unisys Stealth® Software may be found in several pending and commonly assigned U.S. patent, U.S. patent applications and U.S. Patent publications:
U.S. Patent Publication No. 201010125730A1, entitled “BLOCK LEVEL DATA STORAGE SECURITY SYSTEM”, filed 17 Nov. 2008;
U.S. Patent Publication No. 2010/0153740, entitled “DATA RECOVERY USING ERROR STRIP IDENTIFIERS”, filed 17 Dec. 2008;
U.S. Provisional Application No. 60/648,531, filed Jan. 31, 2005, entitled “INTEGRATED MULTI-LEVEL SECURITY SYSTEM”;
U.S. Patent Application No. 2010/0154053A 1, entitled “STORAGE SECURITY USING CRYPTOGRAPHIC SPLITTING”, filed 17 Dec. 2008;
U.S. Patent Application No. 201010154053A1, entitled “STORAGE SECURITY USING CRYPTOGRAPHIC SPLITTING”, filed 17 Dec. 2008;
U.S. Patent Application No. 2010/0153670A1, entitled “STORAGE SECURITY USING CRYPTOGRAPHIC SPLITTING”, filed 17 Dec. 2008;
U.S. patent application Ser. No. 12/336,568, entitled “STORAGE SECURITY USING CRYPTOGRAPHIC SPLITTING”, filed 17 Dec. 2008;
U.S. patent application Ser. No. 12/342,438, entitled “STORAGE AVAILABILITY USING CRYPTOGRAPHIC SPLITTING”, filed 23 Dec. 2008;
U.S. patent application Ser. No. 12/342,464, entitled “STORAGE AVAILABILITY USING CRYPTOGRAPHIC SPLITTING”, filed 23 Dec. 2008;
U.S. patent application Ser. No. 12/342.547, entitled “STORAGE OF CRYPTOGRAPHICALLY-SPLIT DATA BLOCKS AT GEOGRAPHICALLY-SEPARATED LOCATIONS”, filed 23 Dec. 2008;
U.S. patent application Ser. No. 12/342,523, entitled “RETRIEVAL OF CRYPTOGRAPHICALLY-SPLIT DATA BLOCKS FROM FASTEST-RESPONDING STORAGE DEVICES”, filed 23 Dec. 2008;
U.S. Pat. No. 8,286,798B2, entitled “BLOCK-LEVEL DATA STORAGE USING AN OUTSTANDING WRITE LIST”, filed 23 Dec. 2008;
U.S. Patent Publication No. 2010/0162005A1, entitled “STORAGE COMMUNITIES OF INTEREST USING CRYPTOGRAPHIC SPLITTING”, filed 23 Dec. 2008;
U.S. Patent Application Ser. No. 12/342,575, entitled “STORAGE COMMUNITIES OF INTEREST USING CRYPTOGRAPHIC SPLITTING”, filed 23 Dec. 2008;
U.S. Patent Publication No. 2010/016981A1, entitled “STORAGE COMMUNITIES OF INTEREST USING CRYPTOGRAPHIC SPLITTING”, filed 23 Dec. 2008;
U.S. Public Publication No. 2010/0162002A1, entitled “VIRTUAL TAPE BACKUP ARRANGEMENT USING CRYPTOGRAPHICALLY SPLIT STORAGE”, filed 23 Dec. 2008;
U.S. Patent Application No. 2010/0084545A1, entitled “Methods and Systems for Implementing a Secure Boot Device Using Cryptographically Secure Communications Across Unsecured Networks”, filed 11 May 2011;
U.S. Patent Publication No. 2010/0317720, entitled “NEGOTIATION OF SECURITY PROTOCOLS AND PROTOCOL ATTRIBUTES IN SECURE COMMUNICATIONS ENVIRONMENT,” filed Sep. 30, 2013:
U.S. Patent Publication No. 2014/0317405A1, entitled “SECURED COMMUNICATIONS ARRANGEMENT APPLYING INTERNET PROTOCOL SECURITY,” filed Sep. 10, 2013; and
U.S. Pat. No. 9,596,077B2, entitled “COMMUNITY OF INTEREST BASED SECURED COMMUNICATIONS OVER IPSEC,” filed Sep. 30, 2013.

All of the U.S. Patent, U.S. Patent applications, and U.S. Patent Publications listed above are hereby incorporated by reference as if they were set out here in their entirety.

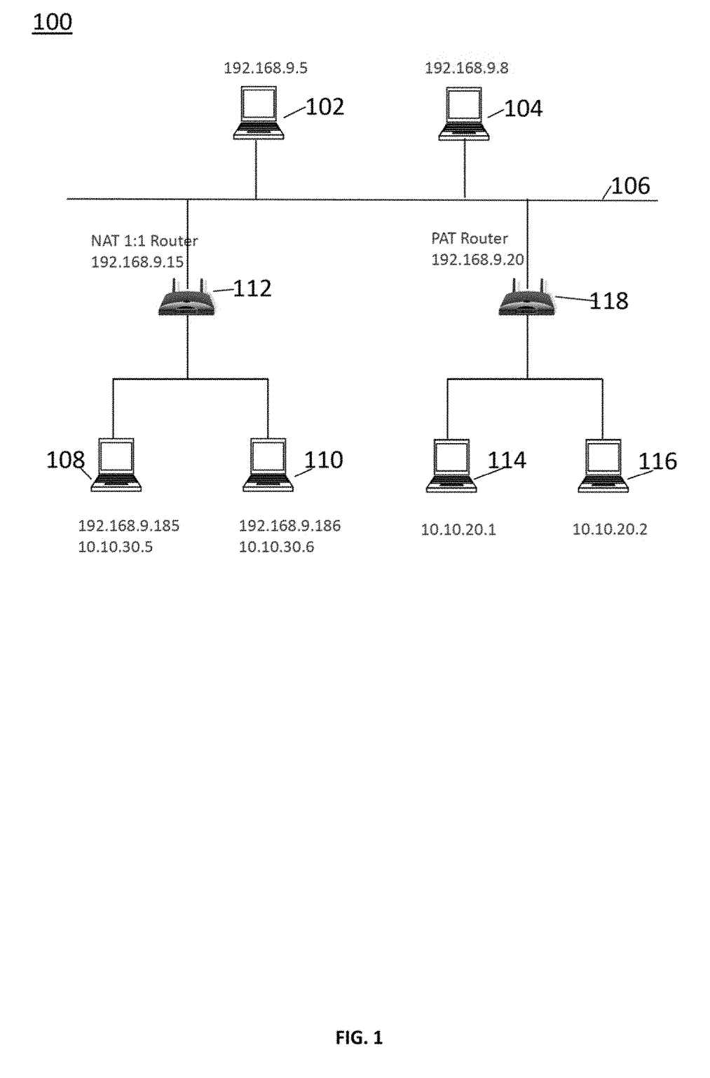

FIG. 1 is an example of a NAT/PAT network configuration 100 in which embodiments of the invention may be practiced. In this example, two servers 102, 104, having IP addresses 192.168.9.5 and 192.168.9.8, respectively, are coupled to a network 106. The server 102 is a non-legacy endpoint or device that supports NAT/PAT traversal in accordance with embodiments of the invention. The server 104 is a legacy device that does not support NAT/PAT traversal. The network 106 may be an intranet or the Internet, for example. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate. The servers may be personal computers, laptop computers, database servers, and/or web services, for example. Clients access applications hosted on servers via networks, as is known in the art.

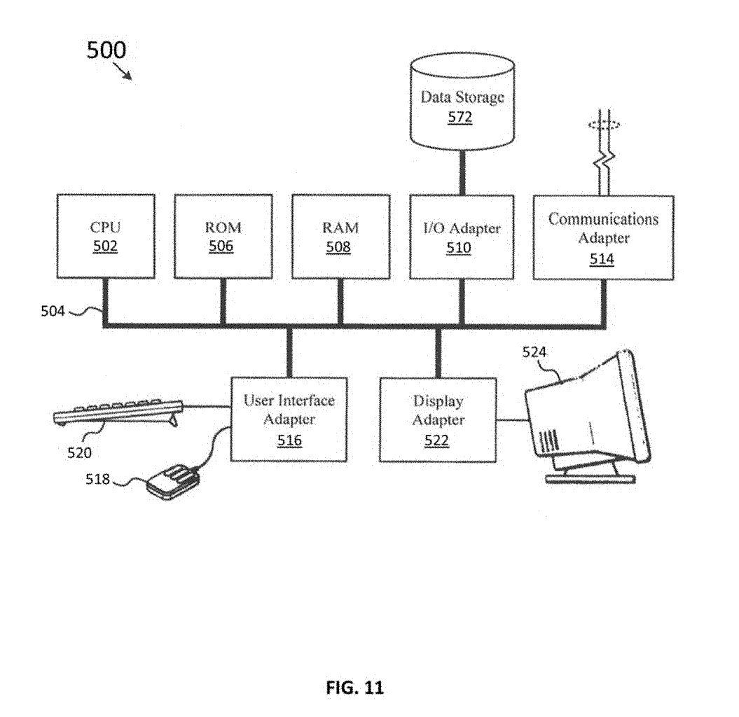

A first client 108, having a public IP address of 192.168.9.185 and a private IP address 10.10.30.5, and a second client 110 having a public IP address 192.168.9.186 and a private IP address of 10.10.30.6 are coupled to the network 106 via a NAT 1:1 router 112 having an IP address of 192.168.9.15. NAT 1:1 routers are referred to as NAT routers herein. The server 108 and the server 112, which are behind the NAT router 112, are also referred to as NAT endpoints. A third client 114 having a private IP address of 10.10.20.1 and a fourth client 116 having a private IP address of 10.10.20.20 are coupled to the network 106 via a PAT router 118 having a public IP address of 192.168.9.20. The server 114 and the server 116, which are behind the PAT router 118, are also referred to as PAT endpoints. The IP addresses in FIG. 1 are exemplary and the components in FIG. 1 may have other IP addresses. A block diagram of a processing device that could serve as the servers and clients of FIG. 1, is shown in FIG. 11. FIG. 11 is discussed in more detail, below. Operation of the servers 102, 104, 108, 110, 114 is controlled by a respective CPU or processor 502 under the control software stored in appropriate non-transitory computer readable medium storage devices(s). Embodiments of the invention may be practiced in network configurations including a single NAT router 112, a single PAT router 118, or multiple NAT routers and/or PAT routers. It is noted that “device” and “endpoint” are used interchangeably herein.

In accordance with an embodiment of the invention, NAT/PAT traversal in an environment, such as the environment of FIG. 1, is supported on Windows and Linux platforms running Unisys Stealth® Software, updated as described herein. Unisys Stealth® Software is available from Unisys, Corporation, Blue Bell Pa. Embodiments of the invention are also applicable to other software products enabling IP Sec communications, as well as other communications using other security protocols.

In the example of FIG. 1, in accordance with embodiments of the invention, the server 102 may communicate with the client 108 and the client 110, which are behind the NAT router 112, and with the client 114 and the client 116, which are behind the PAT router 118. The client 114 and the client 116 may also communicate with the client 108 and the client 110, across the PAT router 118 and the NAT router 112. In addition, the server 102, and the non-legacy server 104 may communicate with each other, in accordance with embodiments of the invention, while in this example, the legacy server 104 cannot communicate with a server hind the NAT router 112 or the PAT router 118 (the client 108, the client 110, the client 114, or the client 116). As used herein, clients that are “behind” the PAT router 118 or the NAT router 112 are part of a private network with the respective router. As used herein, a client or server “in front of” the PAT router 118 or the NAT router 112 is outside of the private network of the PAT router or the NAT router, respectively. For example, the server 114 and the server 116 are behind the PAT router 118, while the servers 102, 108, 110 are in front of the PAT router, and the server 108 and the server 110 are behind the NAT router 112.

As is known in the art, when traffic traverses a PAT router, such as the PAT router 118 in FIG. 1, the PAT router changes the source IP address and source port of the server or client sending the communication, to its own IP address and source port. The remote endpoint then uses the IP address and source port of the PAT router 118 as the destination IP address and destination port on all data returned to the endpoint behind the PAT router. This allows the PAT router 118 to properly map the traffic to the correct destination (the server 114, for example) in its private network. However, this may make it difficult for the receiving endpoint to determine if the source port has been randomly chosen by the sending endpoint or has been changed by a PAT router 118 in the path. Embodiments of the invention address this problem.

NAT 1:1 routers, which are configured to assign a respective public address to each device behind the router, change the private IP address of the endpoint in outbound messages to the public IP address of the endpoint, changes the public IP address endpoint in the inbound messages to the private IP address of the endpoint, and source addresses to its own. This also makes it difficult for receiving endpoints to determine the private IP address of endpoints behind the NAT router. Embodiments of the invention also address this problem.

To support NAT/PAT traversal using Stealth (SCIP and IPsec) protocol in this example, a receiving endpoint learns the private IP address of an endpoint behind a NAT/PAT router based on information in a message or PDU received from the sending endpoint, in order to create the policies for building the IPsec Security Associations (“SAs”). SAs include whether to use IPsec Transport Mode or IPsec Tunnel mode, for example. Policy creation is known in the art. To accomplish this, the private IP address and the original source port are communicated from the NAT/PAT endpoint to the global endpoint in an encrypted portion of the PDU. This is in contrast to IP headers, which are not encrypted and are modified by NAT/PAT routers to change source IP addresses and ports to their own IP address and port, as is known in the art. The encrypted portion of the PDU follows an OID_NAT_Router (or “NAT Option”), which is, added to the payload of both the Sess1 (or “S1”) and Sess2 (or “S2”) PDUs. This option is included on all outgoing Sess1 and Sess2 PDUs sent by endpoints that support NAT/PAT traversal.

To further support Stealth endpoints behind NAT/PAT routers, in one example, the create/search algorithm used to identify a tunnel entry for a Stealth tunnel in tables maintained by respective endpoint devices are enhanced to generate search criteria from a combination of the local IP address, the public remote IP address, and the source port obtained from either the port identified in the PDU or in the OID_NAT_ROUTER option when SCIP IDLE PDUs are received. Backward compatibility is thereby supported in embodiments of the invention to allow an endpoint running the updated Unisys Stealth® Software, described herein and also referred to SCIP version 2, to properly identify an endpoint running the non-updated SCIP such as SCIP version 1, which may not use the SCIP port as the support port for all SCIP PDUs.

### SCIP Protocol

In order to support the SCIP protocol over a NAT/PAT router, in one example of an embodiment of the invention, the following changes are made to the SCIP protocol known in the art to a SCIP version 2 protocol:
1) Move to SCIP Version 2 for SCIP negotiation; and
2) Always use the SCIP port (51294) as the source port for SCIP PDUs.

To further support the SCIP protocol over a NAT/PAT router, in one example of an embodiment of the invention, one or more of the following changes are made to the to the operation of endpoint devices:
1) Use SCIP version negotiation to detect legacy devices that do not support NAT/PAT (SCIP Version 2);
   3) Enhance SCIP and IDLE PDUs with options used to identify endpoints be NAT/PAT routers;
   4) Detect the presence of NAT/PAT router(s) in the data path between endpoints;
   5) Dynamically configure IPSec transport mode or tunnel mode based on NAT Options;
6) Return SCIP Session PDUs to the source IP address and source port on which they are received;
7) Return SCIP IDLE PDUs using the PAT router source port when applicable; and
8) Return SCIP Session 6 PDUs from NAT/PAT endpoints to keep the SCIP tunnel source ports aligned and PAT router mapping active to prevent reuse of a source port associated with an existing Stealth tunnel.

The SCIP version is set to the new, SCIP version 2, as described herein, for all endpoints that support NAT/PAT traversal, to enable the Session PDU to contain an indication that the endpoint that issued the Session PDU supports NAT/PAT router traversal. SCIP version 2 is also used because Windows endpoints do not use the SCIP port (51294) as the source port on outgoing SCIP PDUs. The indication that SCIP version 2 is being used may be a non-encrypted portion of the PDU, for example.

The second change to the SCIP protocol is that all PDUs sent from an endpoint that supports PAT traversal always used the SCIP port, which is 51294, as both the destination port and the source port for all session PDUs, as discussed further below. The changes related to the operation of the endpoints are described below.

As is known in the art, IPSec transport mode is an encryption mode in which the original IP header of a packet is not encrypted along with the other data. This allows the NAT router 112, and/or the PAT router 118 to change the source/destination IP address on the packet. For this reason, IPSec transport mode is used for NAT/PAT traversal, in accordance with an embodiment of the invention. In IPSec tunnel mode, in contrast, the original IP header is encrypted along with the other data and cannot be modified by the NAT/PAT router. For this reason, IPSec transport mode is used for further communications when a NAT/PAT router is not detected during SCIP tunnel negotiation.

The exchange of the S0, S1, and S2 SCIP PDUs allows each local receiving endpoint to determine its position in the Stealth connection/tunnel i.e., determining it is behind a NAT/PAT and if the remote or sending endpoint is a legacy or NAT/PAT endpoint. In the exchange it is the sending side that provides the information, but the receiving side that uses the information to determine its position as well as the remote endpoint's position relative to itself.

This is accomplished in accordance with an embodiment of the invention through use of the NAT Option, which is encrypted and does not change when a NAT/PAT router is traversed. IP headers of PDUs, in contrast, are not encrypted and are modified when the PDU traverses a NAT/PAT router. When a receiving endpoint detects the OID_NAT_ROUTER option or NAT Option in an incoming session PDU, it compares the table entries for the Stealth tunnel to the IP addresses and source ports contained in the NAT Option. If do not match, the receiving endpoint determines that a NAT/PAT router is between the receiving endpoint and the sending endpoint. A receiving endpoint can also learn the private IP addresses of remote endpoints that are behind a NAT/PAT router. If it is determined that a NAT/PAT router is between two endpoints, then transport mode is used in further communications between the endpoints.

### Legacy Devices

Since Stealth Windows endpoints prior to the 3.1.4 release of Unisys Stealth® software use ephemeral source ports for all SCIP PDUs, it may be difficult to distinguish between these legacy Windows endpoints (or “legacy endpoints”) and true PAT endpoints. A mechanism is provided to support backward compatibility between endpoints running with support for PAT traversal and legacy Windows endpoints (i.e. 2.8 or 3.0). The mechanism is part of the search algorithm, which is described below.

The initiator/S0 PDU may support SCIP version 1 or SCIP version 2 and the responder/S1 PDU may support SCIP version 1 or SCIP version 2. Both the sending device and the receiving device must support SCIP version 2 to support NAT/PAT communications between them. In accordance with an embodiment of the invention, the SCIP version in all outbound S0 PDUs endpoints supporting NAT/PAT traversal is set to version 2. The remote endpoint indicates the SCIP version it supports when it returns the S1 PDU and that version will determine if the communications between the endpoints will support NAT/PAT traversal using IPSec transport mode.

In this example, the updated Unisys Stealth® Software in accordance with embodiments of the invention supports the initiation of tunnels under one or more of the following circumstances even if NAT/PAT traversal is not supported:
1) Legacy endpoint tunnel initiation to a non-legacy endpoint (NAT/PAT traversal not supported);
2) Non-legacy endpoint tunnel initiation to a legacy endpoint (NAT/PAT traversal not supported);
3) PAT endpoint tunnel initiation to a non-legacy endpoint (NAT/PAT traversal supported);
4) NAT endpoint tunnel initiation to a non-legacy endpoint (NAT/PAT traversal is supported); and/or
5) Legacy endpoint tunnel initiation to a legacy endpoint (NAT/PAT traversal not supported).

One or more tables of tunnel parameters are maintained by the initiator of a tunnel, which sends an S0 PDU, and one or more tables of tunnel parameters is maintained by the responder to the S0 PDU, which returns an S1 PDU. The tables are searched by the respective device based on criteria that depends on the type of remote endpoint and the type of local endpoint. From the point of view of the initiating device, the local endpoint is the initiating device and the remote endpoint is the device to which the S0s PDU is sent. From the point of view of the receiving device, the receiving device is the local endpoint and the remote endpoint is the initiating device.

The initiating device and the responding device search their respective tables and create, identify, update and/or detect table entries based on the type of endpoint. Local legacy endpoints search their tables for remote sending endpoint entries via the local IP address (“LIP”) and remote IP address (“RIP”). Local non-legacy endpoints search for remote legacy entries via LIP, RIP, and source port (source port=0). Local non-legacy endpoints search for remote non-legacy entries via LIP, RIP, and the source port in the inbound message (source port=x, source port y, for example). It is assumed that an inbound PDU is from a legacy device, when the table is first searched.

On Windows endpoints, the search criteria is used to generate a hash table index that is then used to identify a hash bucket. Identical buckets are searched for a matching entry. On Linux endpoints, the criteria is used to search but no hashing is done. In the following discussion, the term “search” is used to encompass both generating the hash table index for Windows endpoints and searching without hashing for Linux endpoints.

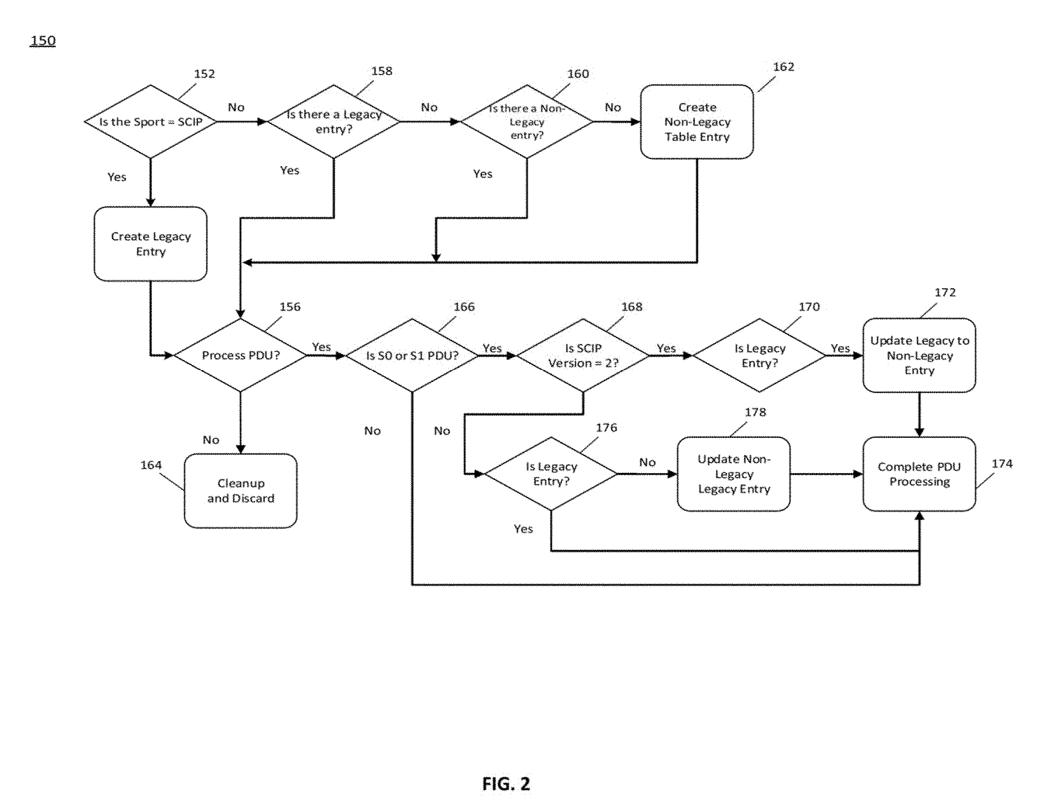

FIG. 2 is a flowchart of an example of a method 150 to identify a remote endpoint as either a legacy endpoint or a NAT/PAT endpoint, in accordance with an embodiment of the invention. As discussed above, different search criteria are used to search the table to distinguish and identify remote legacy endpoints versus remote, non-legacy endpoints that support NAT/PAT traversal. Legacy endpoints are identified using the local IP address (“LIP”) remote IP address (“RIP”), and the remote source port equal to zero (“port=0”), while remote PAT endpoints are identified using the LIP, RIP, and the actual remote source port (source port=x, source port=y, for example). In one example, a single table may be searched by different search criteria to identify entries in the table. In this case, if an entry is found matching the search criteria LIP, RIP, and port=0, then the endpoint sending the PDU is identified as a legacy endpoint that does not support NAT/PAT traversal. If an entry is found matching the search criteria LIP, RIP, port=x or port=y, for example, then the endpoint is identified as a non-legacy endpoint that supports NAT/PAT traversal. Multiple tables may be provided on either or both devices, and/or different tables, such as a legacy endpoint table and a non-legacy table, may also be used.

When a tunnel is initiated by a remote, sending device by sending an S0 PDU to a local receiving device, the local device receiving the inbound S0 PDU may use the method of FIG. 2 to determine if the remote endpoint is a legacy Windows endpoint using an ephemeral source port or a NAT/PAT endpoint using port=x or port=y, for example, which supports NAT/PAT traversal.

In FIG. 2, an inbound SCIP PDU is received by a receiving device and it is determined by the receiving device whether the source port of the initiating device sending the inbound SCIP PDU (the remote source port) is the SCIP source port (Sport=SCIP), in Step 152. As discussed above, the SCIP port is port 51924. If Yes, then a legacy entry to the table of the receiving device is created in Step 154 and it is determined by the receiving device whether to process the inbound SCIP PDU, in Step 156. The determination to process the SCIP PDU is based on standard session PDU processing known in the art, including verification that the endpoints share a common community of interest (“COI”) during Sess0 and Sess1 PDU processing, and that a session PDU can be properly decrypted by the receiving endpoint, for example.

The method 150 starts by creating a legacy entry because it may need to handle scenarios where a tunnel is opening via inbound traffic (inbound S0 PDU) and via outbound traffic (sending a S0 PDU) at the same time. This can happen when traffic is being both sent and received at the exact same time.

If the remote source port of the inbound SCIP PDU is not the SCIP source port (No in Step 152), the remote endpoint may still be a legacy endpoint. In this example, the legacy endpoint criteria (LIP, RIP, remote source port=0) is used to search for legacy entry in the table maintained by the receiving device that matches the LIP address, the RIP address, and port=0, in Step 158. If a legacy entry exists in the table (Yes in Step 158), processing of the inbound PDU continues with that entry, in Step 156.

If a legacy entry does not exist (No in Step 158), non-legacy search criteria (LIP, RIP, and source port of the inbound PDU) are used to search for an entry in the table, in Step 160. If an entry is found in the table (Yes in Step 160), that entry is used to process the inbound PDU, in Step 156. If not (No in Step 160), a new endpoint table entry is created in Step 162 using the non-legacy criteria (LIP, RIP and source port of the inbound PDU), and that entry is used to continue processing in Step 156. Keys are not updated in Step 156.

If it is determined not to process the PDU in Step 156, the PDU is cleaned up and discarded in a wanner known in the art, in Step 160, as discussed above. If it is determined that the PDU is to be processed (Yes in Step 156), it is determined whether the PDU is an S0 PDU or an S1 PDU, in Step 166. The type of PDU can be readily determined based on information in the PDU, as, is known in the art. If the PDU is an S0 PDU or an S1 PDU (Yes in Step 166), it is determined whether the remote endpoint that sent the PDU supports SCIP version 2, in Step 168. Each S0 and S1 PDU contains a bit mask that includes information that indicates the SCIP version, as well as the IPSec attributes used to establish the IPSec communications between the two endpoints, as is known in the art.

If the PDU is not an S0 PDU or an S1 PDU (No in Step 166), then processing of the PDU is completed, in Step 174, depending on the type of PDU.

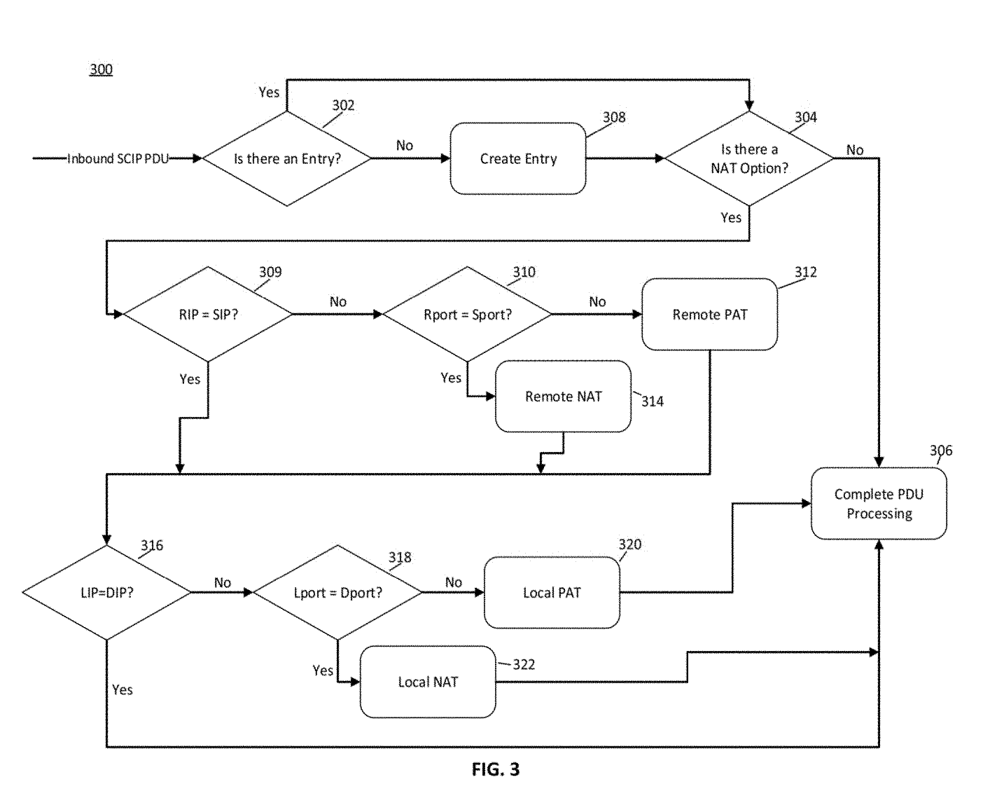

If the remote endpoint does support SCIP version 2 (Yes in Step 168), then the current entry is checked to see whether it should be updated in the table using the legacy create/search criteria, in Step 170. If Yes, then the legacy entry is updated in Step 172. PDU processing is then completed, as described further below with respect to FIG. 3 for example.

If the remote endpoint does not support SCIP version 2 (No in Step 168), then the current entry is checked in Step 176 to see if it should be updated in the table using the remote source port in the create/search criteria. If Yes in Step 176, processing of the PDU is completed, in Step 174. If No in Step 176, then the endpoint entry is changed in the table, in Step 178, and PDU processing is completed, in Step 174. If the PDU is not an S0 or S1 PDU (No in Step 166), then PDU processing is completed, in Step 174.

When additional inbound PDUs (S2, S6, IDLE and/or TERM PDUs, for example) are received (No in Step 166), the Stealth tunnel entry for processing these PDUs will be present in the table and marked as either a SCIP version 1 (legacy) or a SCIP version 2 (non-legacy) remote endpoint.

The process 150 of FIG. 2 may also be used by the initiating legacy device 202 when it sends an S0 PDU to initiate a Stealth tunnel. In this example, when a tunnel is initiated due to an outbound S0 PDU, a Stealth tunnel entry to the table maintained by the initiating device is created using legacy search criteria (LIP, RIP, port=0). It is again assumed that the remote endpoint is a legacy device to allow responses from legacy endpoints, here the S1 PDU to be properly routed to the correct table entry. Since PDUs from legacy endpoints have ephemeral source ports which change on each PDU, the source port cannot be used in the search criteria. By assuming a legacy endpoint and always using 0 to find these entries, inbound PDUs will be routed to the correct table entry for processing. To properly route the inbound S1 PDU in this example, a legacy entry must be present in the table. If the remote endpoint is later determined to support SCIP version 2, the Stealth tunnel entry in the table is updated to be non-legacy.

If the remote source port of the inbound S1 SCIP PDU sent by the remote endpoint after receiving the S0 SCIP PDU is not the SCIP source port (51294), in Step 152 of FIG. 2, the table is checked for a legacy entry that matches the LIP and RIP of the S1 PDU, in Step 158. Since a legacy endpoint table entry was initially created, above, processing of the inbound S1 PDU continues in Step 156 with that entry.

If the inbound PDU is an S1 PDU (Yes in Step 166), then the SCIP version is checked in Step 168. If the inbound S1 PDU SCIP has SCIP version 2 set in its bit mask, as discussed above, then the legacy entry created when the S0 PDU was generated is present (Yes in Step 170), and the table entry is updated using the LIP, RIP and the source port specified in the S1 PDU, in Step 172. Once the entry has been updated, PDU processing is completed in Step 174 and an S2 PDU is returned to the source port specified in the received S1 PDU.

If the SCIP version is not version 2 (No in Step 168), the legacy entry remains unchanged in the table (Yes in Step 176) and the remote endpoint is marked as SCIP version 1 (legacy). The S2 PDU is then sent using the SCIP port.

When additional inbound PDUs (S6, IDLE and/or TERM PDUs) are received, a Stealth tunnel entry for processing these PDUs will be in the table and marked as either a SCIP version 1 (legacy) or a SCIP version 2 remote endpoint.

### NAT Option

As discussed above, the updated Unisys Stealth® Software in accordance with an embodiment of the invention includes a NAT Option in the PDU sent by non-legacy endpoints that identifies the port from which the PDU is sent (source port), the port to which the PDU is sent (destination port), the IP address the of the endpoint sending the address (source IP address), and the IP address of the endpoint to which the PDU is being sent (destination IP address). The NAT Option is in a part of the PDU which is encrypted. It cannot, therefore, be modified by a NAT or PAT router when traversing the router. This information is also included in the IP header of the PDU, however, since the IP header is modified by the NAT router 112 and the PAT router 118 during PDU traversal, the IP header cannot be used to identify endpoints behind the NAT router or the PAT router. In addition, differences between the information in the NAT Option and the IP header (or table entries based on the IP header), are used to determine whether an endpoint is behind a NAT router or a PAT router. Whether a NAT/PAT router is present along the communication tunnel between two endpoints determines whether IPSec tunnel mode or IPSec transport mode is used in further communications between the endpoints. As discussed herein, if a NAT/PAT router is determined to be present, then IPSec transport mode is used. If no NAT/Pat router is present, then IPSec tunnel mode is used.

When a first endpoint sends a message to a second endpoint, the first endpoint is a local endpoint, the second endpoint is a remote endpoint, the IP address of the first endpoint is identified as a local IP address in the table maintained by the first endpoint, and the IP address of the second endpoint is a remote IP address in the table maintained by the first endpoint. When the second endpoint receives the message and sends a return message, the roles are reversed. The second endpoint is now a local endpoint and the first endpoint is a remote endpoint. When the second endpoint sends a message to first endpoint, the local IP address in the table maintained by the second endpoint is the IP address of the second endpoint, while the remote IP address is the IP address of the first endpoint, with respect to the second endpoint. The same is true for the source ports.

Below is a table correlating the fields of inbound PDUs with fields in the table entries of the device receiving the PDU (receiving device), and the fields in the NAT Option of the outbound PDU sent by the receiving device in response to the inbound PDU. A Destination IP address (“DIP”) in an inbound PDU corresponds to the Local IP Address (“LIP”) in the table entry of the receiving device, and to the Source IP Address (“SIP”) in the NAT Option that the receiving device will put in the outbound PDU. The Source IP address (“SIP”) in the inbound PDU corresponds to the Remote IP Address (“RIP” in the table entry, and corresponds to the Destination IP Address (“DIP”) in the NAT Option in an outbound PDU sent by the receiving device. The source part (“Sport”) in the inbound PDU corresponds to the Remote Port (“RPort”) in the table entry of the receiving device, and to the Destination Port (“DPort”) in the NAT Option in the outbound PDU. The Destination Port (“DPort”) in the inbound PDU corresponds to the Local Port (“LPort”) in the table entry of the Source Port (“SPort”) in the NAT Option sent by the receiving device. These designations are used in FIG. 3, which is discussed below.

| Inbound | | Outbound NAT Option Field |
|---|---|---|
| Packet Field | Table Field | Outbound Packet Fields |
| Destination IP | Local IP Address (LIP) | Source IP Address (SIP) |
| Address (LIP) | | |
| Source IP | Remote IP Address (RIP) | Destination IP Address (DIP) |
| Address (SIP) | | |
| Source | Remote Port (RPort) | Destination Port (DPort) |
| Port (Sport) | | |
| Destination | Local Port (LPort) | Source Port (SPort) |
| Port (DPort) | | |

FIG. 3 is a flowchart of an example of a method 300 for processing messages between non-legacy devices to determination whether a PAT router and/or an NAT router is present, in accordance with an embodiment of the invention. An inbound Sess0 of Sess1 SCIP PDU is received by a receiving device, which searches its table for an entry corresponding to the information in the message, in Step 302. The receiving device assumes the device is a legacy device, as above, and searches its table using legacy criteria (LIP, RIP, Source port=0). If there is a match, then it is determined whether there is a NAT Option in the message, in Step 304. If No, then it is determined that there is not a PAT router or an NAT router between the remote (sending) and local (receiving) endpoints, and PDU processing is completed, in Step 306. In one example, IPSec tunnel mode is then selected for future communications.

If no table entry is found, in Step 302, then a table entry is created, in Step 308.

If there is an NAT Option in the Stealth message (Yes in Step 304), it is determined whether the source IP address (“SIP”) in the NAT Option is the same as the remote IP address (“RIP”) in the table entry. If not (No in Step 309), it is determined whether the NAT Option source port (“SPort”) matches the remote port (“Rport”) in the table entry. If the two ports do not match (No in Step 310), then it is determined that the remote (sending device) is behind a PAT router and the table entry for the entry is marked to indicate that the device is a remote PAT endpoint, in Step 312. The process then proceeds to Step 316.

If the Rport matches the Sport in the table entry (Yes in Step 310), then the receiving device determines that the remote, sending device is behind a NAT router and the table entry is marked to indicate that the sending device is a remote NAT endpoint, in Step 314.

If the SIP matches the RIP, in Step 309, then it is determined whether the destination IP (“DIP”) matches the local IP address (“LIP”) in the table entry, in Step 316. If they match (Yes in Step 316), neither a PAT router nor a NAT router are between the sending and receiving devices, and PDU processing is completed in Step 306. In one example, IPSec tunnel mode is selected for future communications, as above.

If the DIP does not match the LIP (No in Step 316), then the local port (“LPort”) in the table entry is compared to the destination port (“DPort”) in the NAT Option. If they do not match, then it is determined that the receiving device is behind a PAT router and the table entry is marked local PAT endpoint, in Step 320, where IPSec transport mode policies are adopted by the receiving device for further communications.

If the DPort matches the LPort (Yes in Step 318), then it is determined that the receiving device is behind a local NAT router and the table entry for the device is marked as a local NAT endpoint, in Step 322. Processing is then completed in Step 306, where IPSec transport mode policies are adopted by the receiving device for further communications.

It is noted the position of Steps 309-314 and Steps 316-320 in the flowchart 300 may be reversed. In other words, it may be determined whether a local NAT router or local PAT router is present before determining whether a remote NAT router or remote PAT router is present.

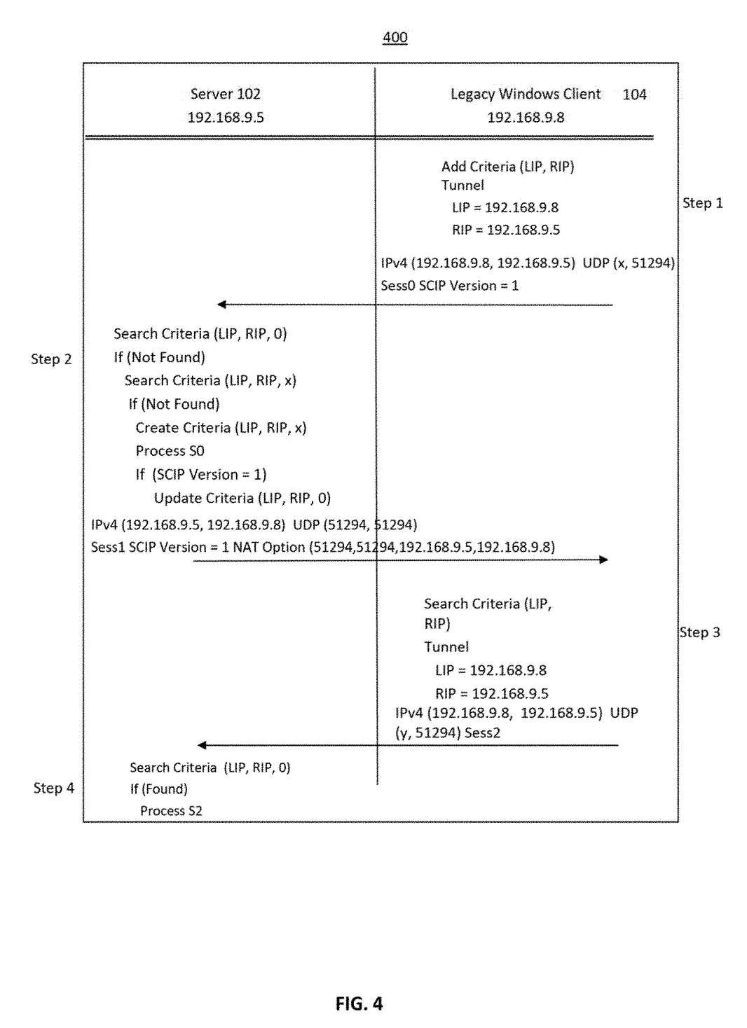

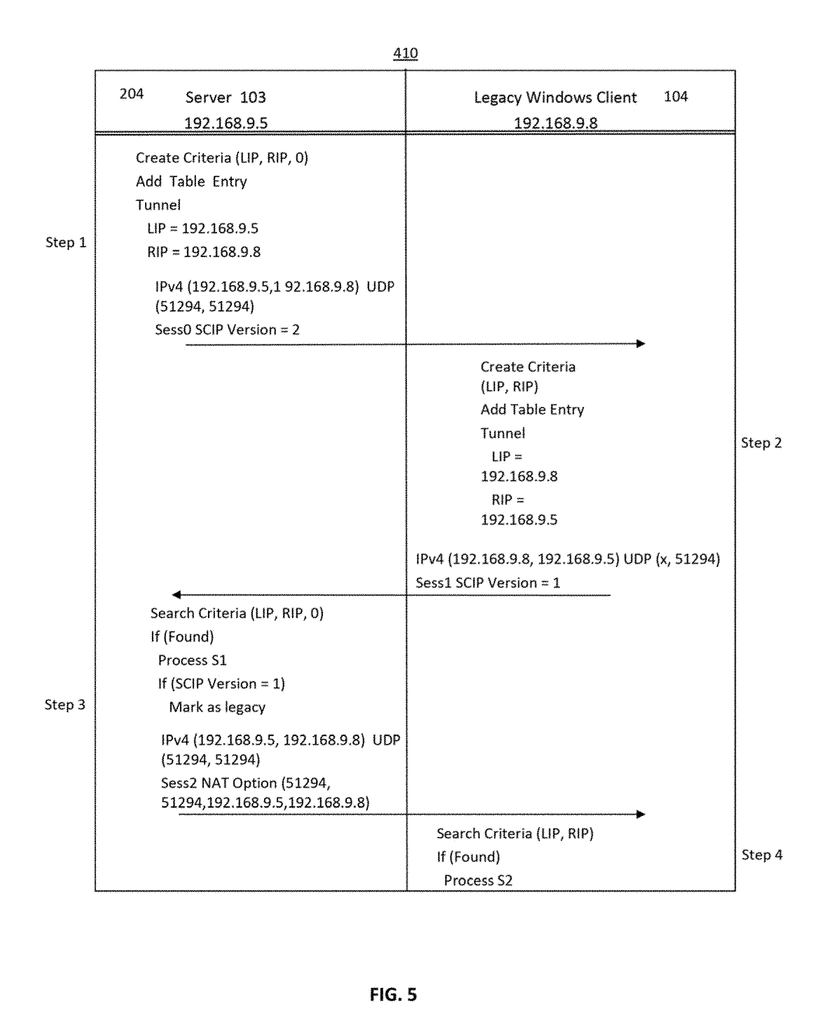

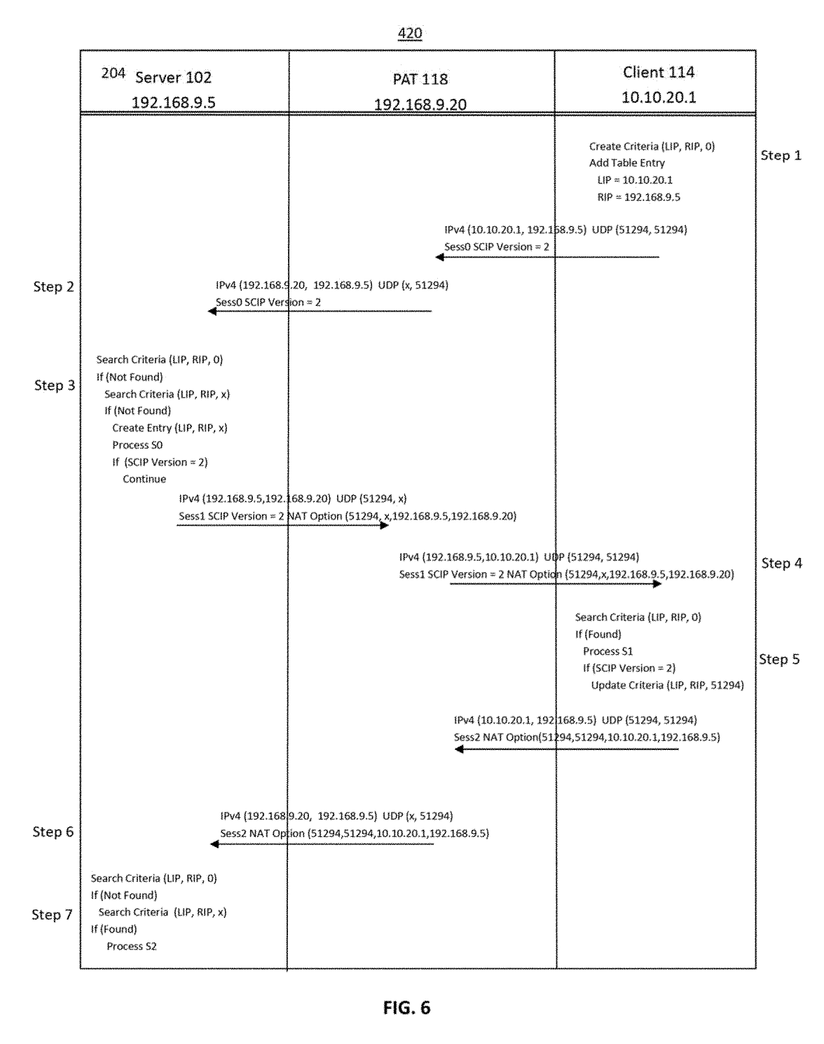

FIGS. 4 and 5 are flow diagrams of examples of communications between legacy and non-legacy devices, in accordance with the method 200 of FIG. 2. FIGS. 6-10B are flow diagrams of examples of communications between non-legacy devices, in accordance with the method 300 of FIG. 3.

FIG. 4 is a flow diagram 400 of an example of a process for handling Stealth tunnel initiation from a legacy Windows endpoint 104 to a non-legacy endpoint 102 of FIG. 1, based on the process 150 of FIG. 2. In this example, the legacy Windows endpoint 104 is a legacy Windows client 104, the operation of which is shown in the right column of FIG. 4. The legacy Windows client 104 in this example has an IP address of 192.168.9.8, which is referred to as local address or “LIP” in Step 1 because in this example the Stealth tunnel is initiated by the legacy Windows client. The legacy endpoint uses 104 SCIP version 1 and does not include an NAT option in the S1 or S2 PDU. The flow diagram therefore proceeds from Step 168 to Step 176 in FIG. 2.

The non-legacy endpoint is a server 102, operation of which is shown in the left column of FIG. 3. The server 102 has an IP address of 192.168.9.5, which is referred to as the remote IP address or “RIP” in Step 1 by the legacy windows client 104 because in this example the client 104 is sending the Sess0 PDU to the server 102. Both the legacy windows client 104 and the non-legacy server 102 use Internet Protocol version 4 (“IPv4”) and User Datagram Protocol (“UDP”) port 51294.

The legacy Windows client 104 initiates a Stealth tunnel with the non-legacy server 102 in Step 1 by creating a table entry in the table maintained by the legacy Windows client 202 including the LIP address of the client and the RIP of the server. A Sess0 (or “S0”) PDU is generated having the form: IPv4 (192.168.9.8, 192.168.9.5) UDP (x, 51294), and sent to the server 102. The IP header is (192.168.9.8, 192.168.9.5), where the first IP address is the IP address of the source of the PDU (the LIP), here the client 104, and the second IP address is the IP address of the endpoint to which the PDU is being sent (the RIP), here the server 102. The PDU includes the following information: using IPv4, a tunnel is to be initiated from a local endpoint having an IP address of 192.168.9.8 (here the LIP (legacy Windows client 104)) to a remote endpoint having an IP address of 192.168.9.5 (here the RIP (non-legacy server 102)), to transfer a PDU in a UDP from any port x of the local endpoint to port 51294 of the remote endpoint. In addition, the PDU indicates that the legacy Windows client 202 uses SCIP version 1.

The non-legacy server 102 receives the Sess0 PDU from the client 104 and searches the table using the remote legacy search criteria, (LIP, RIP, the source port=0), in Step 2 (Step 158 in FIG. 2). If a match is not found, the table is searched again for non-legacy remote criteria (LIP, RIP, and the port in the received PDU, here “x”) (Step 160 in FIG. 2). If a match is not found, an endpoint table entry is created based on the LIP, RIP, and port=x (Step 162 in FIG. 2). If this is the first S0 PDU received from the legacy windows client 202 and a Stealth tunnel has not already been created, then the Stealth tunnel is created. It is noted that a Stealth tunnel may be initiated both inbound and outbound at the same time, if both the client 104 and the server 102 in this example attempt to open the tunnel by sending an S0 PDU, for example. This process resolves the collision.

The S0 PDU is then processed (Step 156 in FIG. 2). If SCIP=1, which it is here, the table entry is updated to LIP, RIP, and port=0 (Step 178, FIG. 2).

In this case, the PDU sent from the server 204 (LIP address 192.168.5) to the client 202 (RIP address 192.168.9.8) is in a UDP from port 51294 of the server to port 51294 of the client because the SCIP version is 1. The NAT Option is always provided in the Sess1 PDU in this example so that the initiating device (the client 202 in this example) can derive information about the receiving device (the server 204 in this example), if the initiating device is capable (if the initiating device is SCIP version 2).

The server 104 generates an S1 PDU in response to the S0 PDU, and sends it to the legacy Windows client 102 at the end of Step 2. Since the server 102 is a non-legacy device that uses the updated Unisys Stealing® Software in accordance with an embodiment of the invention, the S1 PDU include a NAT Option. In this example, the form of the NAT Option is NAT Option (51294, 51294, 192.168.9.5, 192.168.9.8), where the source port, the destination port, the source IP address and the destination IP address are included within the parenthesis following NAT Option. The S1 PDU message is IPv4 (192.168.9.5, 192.168.9.8) UDP (51294, 51294), Sess1 SCIP version=1 NAT Option (51294, 51294, 192.168.9.5, 192.168.9.8). Since the S0 PDU indicated that the client uses SCIP version 1, the S1 PDU also indicates that SCIP version 1 is used. In this example, the PDU sent from the server 204 (LIP address 192.168.5) to the client 202 (RIP address 192.168.9.8) is in a UDP from port 51294 of the server to port 51294 of the client because the SCIP version is 1. Also in this example, NAT Option is always provided in the Sess1 PDU, but that is not required when the Sess 0 PDU indicates the SCIP version 1 is used by the initiating device (the client 106).

In Step 3, the legacy Windows client 104 receives the S1 PDU and searches its table using the search criteria (LIP, RIP), which it used to create the tunnel entry in Step 1. Since legacy clients do not support the NAT Option, the NAT Option is ignored and there is no need to update the table. The client 104 generates a Session 2 (“Sess2”) PDU to send to the server 102. The message is in the form: IPv4 (192.169.98, 192.168.9.5) UDP (y, 51294) Sess2, indicating that the message is from the client 104, to the server 102, from part of the client, to part 51294 of the server.

The server 102 receives the Sess2 PDU in Step 4, and searches the table for the remote legacy criteria (LIP, RIP, 0). Since the server 102 updated its tunnel entry to these criteria in Step 2, a matching entry is found and the server processes the Sess2 (S2) PDU, in Step 4. The Stealth tunnel is considered to be complete when the S2 PDU is sent.

The exchange of S0, S1 and S2 PDUs is used to establish the Stealth tunnel. The tunnel is not complete until all three PDUs have been successfully exchanged.

FIG. 5 is a flow diagram 410 of an example of a process for handling Stealth tunnel initiation from a non-legacy endpoint to a legacy Windows endpoint. The non-legacy endpoint in this example is the server 102 and the legacy Windows endpoint is the client 104 in FIG. 1. Since the legacy client uses SCIP version 1, the flow diagram proceeds from Step 168 to Step 176 in FIG. 2. Since the Stealth tunnel is initiated from the non-legacy endpoint in this example, the local IP address (“LIP”) is the address of the server 204 (192.168.9.5) in Step 1. Similarly, in this example, since the tunnel terminates at the legacy client 202, the remote IP address (“RIP”) is the address of the client 202 (192.168.9.8) in Step 1. The non-legacy server 204 uses SCIP version 2. The NAT option is not included in the first, Sess0 PDU.

A table entry including the legacy search criteria (LIP, RIP, 0) is created and added to the table by the server 102, in Step 1. Legacy search criteria are used to create the first entry even though the server 204 is a non-legacy device, since the remote pod is not known. If the S1 PDU is received with a source port other than the default SCIP port 51294, the associated tunnel may be located in the table as a legacy entry. A Sess0 PDU is then sent to the legacy Windows client 102 to initiate a Stealth tunnel in the message: IPv4 (192.196.95, 192.168.9.8) UDP (51294, 51294) Sess 0 SCIP Version=2.

The legacy client 102 receives the message, creates a table entry including its IP address as the LIP and the IP address of the server 102 as the RIP, and adds the table entry to its table, in Step 2. The client 102 generates a Sess1 PDU and sends the Sess1 PDU to the server 204 in a message IPv4 (192.168.9.9.8, 192.168.9.5) UDP (x, 51294) Sess1 SCIP Version=1. The legacy endpoint uses SCIP version 1, and any port x. Since the client 202 is a legacy client and SCIP version 1, does not include an NAT option in the S1 or the S2 PDU, in FIG. 4.

The server 102 receives the message in Step 3. The server 102 searches its table for the LIP, RIP and the source port=0. If a matching entry is found, the S1 PDU is processed. In this example, the remote port x is ignored because the legacy entries, which are ephemeral (unpredictable and changing), always use port=0 in the table. Since the SCIP version of the S1 PDU is Version 1, the table entry is marked as a legacy device in the table.

The server 102 generates a Sess2 PDU and sends it to the legacy client 104 in the message: IPv4 (192.168.9.5, 192.168.9.8) UDP (51294, 51294) Sess2 NAT Option 51294, 51294, 192.168.9.5, 192.168.9.8, at the end of Step 3. As noted above, since the server 102 is a non-legacy device that uses SCIP version 2, a NAT Option is included in the PDU, even though it has been determined that the remote endpoint (client 104) is a legacy device using SCIP version 1. The legacy client 104 receives the message and searches for legacy criteria (LIP, RIP), in Step 4. If found, the S2 PDU is processed. The entry should be found since the client 202 created a tunnel entry with the search criteria (LIP, RIP) in Step 2.

FIG. 6 is a flow diagram 420 of an example of the use of the method 300 of FIG. 3 to determine whether a PAT router, here the PAT router 118 in FIG. 1, is between the initialing device, here client 114 of FIG. 1, and the receiving device, here the server 102 of FIG. 1, in accordance with an embodiment. The PAT router 118 has an IP address of 192.168.9.20. A client 114 behind the PAT router 206 has a private IP address of 10.10.20.1. The client 114 is not a legacy device and uses SCIP version 2.

The client 114 creates a table entry in its table with the criteria (LIP, RIP, 0), where LIP is the private IP address of the client 114 and the RIP is the public IP address of the server 102. A Session 0 (“Sess0”) PDU is sent by the client 114 to the server 102, through the PAT router 118, to initiate establishment of a Stealth tunnel, in Step 1. The message generated by the client 114 in Step 1 of this example is: IPv4 (10.10.20.1, 192.168.9.5) UDP (51294, 51294), Sess 0 SCIP Version 2. The client 114 uses the SCIP port 51294 to send the Sess0 PDU because the client uses SCIP Version 2.

The message is received by the PAT router 118, in Step 2. As is known in the art, PAT routers, such as the PAT router 118, change the private IP addresses in messages sent by devices behind the PAT router, here the client 114 to its own public IP address. The PAT router 118 also changes the IP address of PDU intended for devices behind the PAT router, such as the client 114, from its own, public IP address to the private IP address of the client 114. The PAT router 114 maintains a table mapping messages to IP address of respective devices behind the PAT router, as is known in the art.

Here, the PAT router 118 changes the LIP of the client 114 to the IP address of the PAT router, and changes the sending port to “x”, resulting in the message: IPv4 (192.168.9.20, 192.168.9.6) UPD (x, 51294) Sess 0 SCIP Version=2. The resulting message is sent to the server 204.

The server 102 receives the message from the PAT router 118, in Step 3, and searches its table using the legacy search criteria (LIP, RIP, 0), as in Step 158 of FIG. 2. If a matching entry is not found, the server 204 searches the table with the non-legacy search criteria (LIP, RIP, x). If a matching entry is not found, the server 102 creates a non-legacy table entry with the criteria LIP, RIP, x (as in Step 162 of FIG. 2), and processes the S0 PDU (as in Step 156 of FIG. 2).

If the sap version is 2, which it is (Yes in Step 168), the server 102 generates the following Sess1 PDU message: IPv4 (192.168.9.5, 192.168.9.20) UPD (51294, x) Sess 1 SCIP version=2 NAT Option (51294, x, 192.168.9.5, 192.168.920). The NAT Option parameters include the LIP address and port the server 102, and the IP address of the PAT router 118 and any port x. The message is sent to the PAT router 118 from devices behind the PAT router, here the client 114, the server 102 does not know the private IP address of the client 114.

The PAT router 118 receives the Sess1 PDU, in Step 4. The PAT router 118 changes the IP header of the PDU to replace the IP address and port of the PAT router by the private IP address and the port of the client 208. The NAT Option is not changed. The PAT router 118 then sends the PDU to the client 208.

The client 114 receives the message in Step 5 and searches for the criteria (LIP, RIP, 0) (Step 158, FIG. 2). If a matching entry is found, the S1 PDU is processed. Since the SCIP of the PDU is version 2 (Step 168, FIG. 2), the legacy criteria are updated by the client 208 to the non-legacy criteria (LIP, RIP, 51294) (Steps 170, 172 FIG. 2).

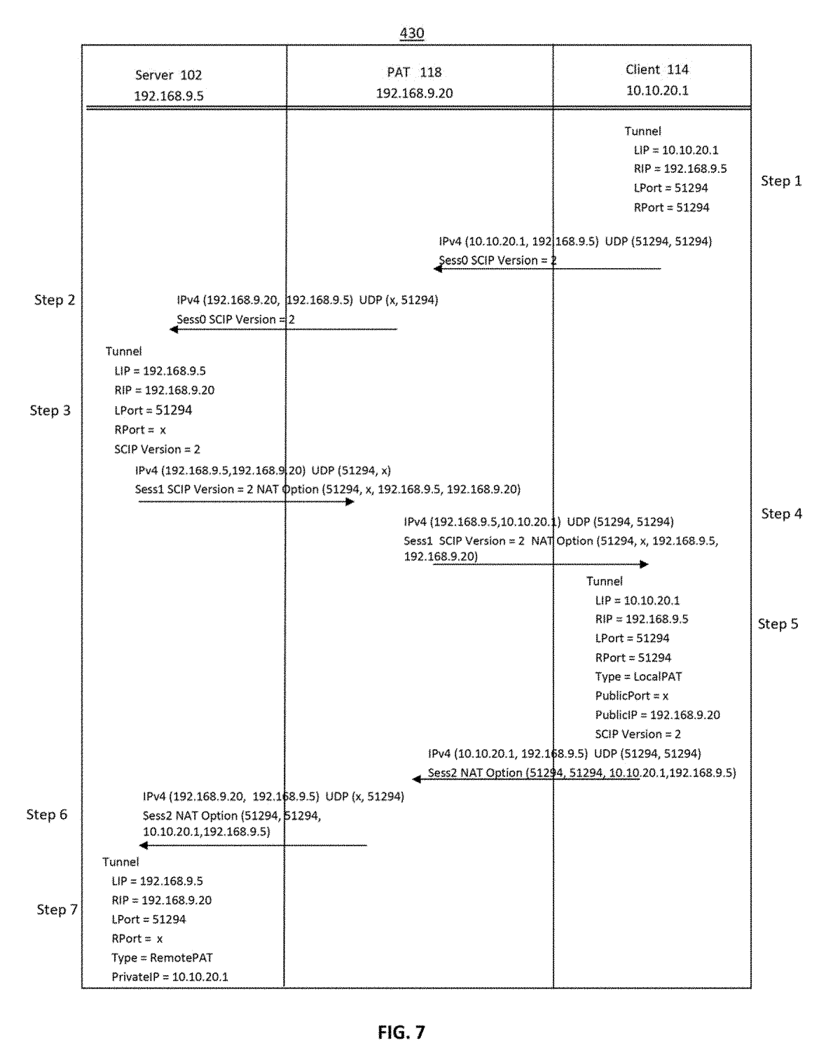

The client 114 reads the Sess 1 PDU and compares the source IP address in the NAT Option (192.168.9.5) to the remote IP address (RIP) in the table entry, as in Step 309 of FIG. 3. Since they match, it is determined that the remote endpoint is not behind a NAT/PAT router. The client 114 then reads the Sess 1 PDU and compares the destination IP address (192.168.9.20) and the destination port (x) in the NAT Option, to its own IP address (LIP) (10.10.21.1) and its local source port (LPort) (51294) in the table entry. The updated table entries are shown in FIG. 7. They are both different (No in Step 406, No in Step 308) because the server 102, which generated the NAT Option, only knows the IP address and port of the PAT router 118. The client 114 therefore determines that it is behind the PAT router 118 and marks the table entry as local PAT, which is also shown in FIG. 7.

The client 114 then generates and sends a Sess2 PDU to the server 204 in a message: IPv4 (10.10.20.1, 192.168.9.5) UDP (51294, 51294), Sess2 NAT Option (51294/51294, 10.10.20.1, 192.168.9.5) through the PAT router 118.

The PAT router 114 receives the S2 PDU in Step 6 and changes the LIP address of the client 118 in the IP header to that of the PAT router. The PAT router 206 also changes the source port from 51294 to x. The following message is generated and sent to the server 102, in Step 6: IPv4 (192.168.9.20, 192.168.9.5) UDP (x, 51294) Sess2 NAT Option (51294, 51294, 10.10.20.1, 192.168.9.5) to the server 102. The PAT router 118 does not and cannot change the NAT Option because the NAT Option is encrypted.

The server 102 receives and reads the Sess 2 PDU in Step 7, and searches for the legacy criteria (LIP, RIP, 0) (Step 158, FIG. 2). The legacy search criteria is not found so non-legacy criteria is searched (LIP, RIP, x). Since the server 102 already created an entry with the criteria (LIP, RIP, x) in Step 3, the entry is found and the S2 PDU is processed.

The server 102 also compares the source address (192.168.9.20) and source port (x) in the NAT Option to the remote IP address (10.10.20.1) and remote port (51294) in the table entry, and determines that they are different. This is because the PAT router 118 replaced the IP address of the client 114 and port in the IP header and UDP, but did not change the NAT Option generated by the client 114. Based on the comparison, the server 102 determines that the client 114 is behind the PAT router 118 (step 312 in FIG. 3) and identifies the IP address of the client as 10.10.20.1. The table is updated to indicate that the there is a remote PAT endpoint, as the Steps 304, 309, 310 and 312 of FIG. 3, and the Stealth tunnel is open.

FIG. 7 is a flow diagram 430 corresponding to FIG. 6, including table entry updates. The client 114 begins tunnel initialization in Step 1 by creating the tunnel with its local private IP address 10.10.20.1 and initiating the S0 PDU to the public address of the server 192.168.9.5. Initialization always begins from the endpoint behind the PAT router 206 because the PAT router 118 establishes a mapping of the endpoints private IP address to its own public IP address and a mapped source port. This mapping allows the PAT router 118 to properly direct traffic from the public endpoint (the server 102) back to the comet PAT endpoint (the client 114).

The client 114 generates a table entry containing the following information LIP=10.10.20.1; RIP−192.168.9.5; local port (“LPort”)=51294; remote port (“RIP”)=51294. The client 114 also generates a message has the form IPv4 (10.10.20.1, 192.168.9.5) UDP (51294, 51294) Sess0 SCIP Version=2, in Step 1. The Sess0 PDU is sent to the PAT router 118.

The S0 PDU is received by the PAT router 118, in Step 2. The PAT router 118 modifies the IP header of the message by replacing the LIP of the client 114 by the IP address of the PAT router, and changing the local port of the client (51294) to the port of the PAT router (x). The resulting message is: IPv4 (192.168.9.20, 192.168.9.5) UDP (x, 51294) Sess0 SCIP Version=2, in Step 2. The modified message is forwarded to the server 204, in Step 3.

The server 102 receives the message in Step 4, searches for a table entry as discussed above with respect to FIG. 6, Step 2, and creates a tunnel entry with the following information: LIP=192.168.9.5; RIP=192.168.9.20 (the IP address of the router 206); LPort=51294; Remote PAT; and Remote Port (RPort=x). The server 102 then generates and returns the S1 PDU to the client 114 using the public address of the PAT router 118 as the destination IP address and the mapped port x as the destination port. The server 102 includes a NAT option in the S1 PDU with the source port, destination port, source IP address and destination IP address. The server 102 generates and sends to the client 206 a message of the form IPv4 (192.168.9.5, 192.168.9.20) UDP (51294, x) Sess1 NAT SCIP Version=2 NAT Option (51294, x, 192.168.9.5, 192.168.9.20), in Step 3.

The PAT router 118 receives the Sess 1 PDU, modifies the IP header to replace the destination IP address and destination port to the original PAT endpoint IP address of the client 208 (10.10.20.1) and destination port of the client (51294), in Step 4, as discussed above. The PAT router 118 modifies the received Sess1 PDU message to: IPv4 (192.168.9.5, 10.10.20.1) UDP (51294, 51294), Sess1 NAT Option (51294, x 192.168.9.5, 192.168.9.20), and sends it to the client 114, in Step 4.

The client 114 processes the S1 PDU and stores the NAT Options in the tunnel table entry, in Step 5. The client 114 compares the destination IP address and the destination port in the NAT Option to those in the table entry, IP header, and UDP, and determines that they are different. Based on this comparison, the client 208 determines that it is behind a local PAT router (PAT router 118) with a public IP address 192.168.9.20 and that the PAT router is using the mapped port x for SCIP tunnel negotiation, as in Steps 304, 309, 316, 318, and 320 of FIG. 3. The client 114 stores the information in and conclusions from the NAT Option (Type+LocalPAT, PublicPort=x, PublicIP=192.168.9.20, SCIP=2), as shown in FIG. 7.

The client 114 generates a Sess 2 PDU, including a new NAT Option. The message is in the form: IPv4 (10.10.20.1, 192.168.9.5) UDP (51294, 51294), Sess 2 Nat option (51294, 51294, 10.10.20.1, 192.168.9.5).

The message is received by the PAT router 118, in Step 206. The PAT router 118 modifies the IP header by replacing the LIP of the client 206 by the IP address of the PAT router and changing the port of the client to the port of the PAT router (x). The NAT Option is not changed by the PAT router 206. The message sent to the server 204 is in the form: IPv4 (192.168.9.20, 192.168.9.5) UDP (x, 51294), Sess2 NAT Option (51294, 51294, 10.10.20.1, 192.168.9.5).

The server 102 receives the message in Step 7, processes the S2 PDU, and reads the NAT Option. The Stealth tunnel is now open. The server 102 compares the destination IP address and the destination port in the table entry to those in the NAT Option, and determines that they are different. Based on this difference, the server 204 determines that there is a remote PAT router with a public IP address 192.168.9.20 and that the PAT router is using the mapped port x for SCIP tunnel negotiation. The server 204 also determines that another device with a private IP address of 10.10.20.1 (the client 114) is behind the PAT router 118, as described in Steps 304, 309, 310 and 312 of FIG. 3. The server 204 stores this information, adding the RPort=x, Type=RemotePAT, and PrivateIP=10.10.20.1, to its table, as shown in FIG. 7.

### SCIP Handling

SCIP IDLE exchange is used by Stealth endpoints to verify that the underlying IPSec communications between two endpoints are still active. Most of the SCIP PDUs are sent outside of the IPSec encrypted tunnel (i.e., they are not Encapsulating Security Payload Protocol (“ESP”) traffic). The only SCIP PDU that is inside of the IPSec encrypted tunnel is the SCIP IDLE PDU, which is IPSec encrypted. ESP traffic that is encrypted as it traverses the NAT router contains headers (IP addresses and ports) that will not be modified by a NAT or PAT router because they are part of the encrypted data. As a result, the IP address or port number of these IPSec encrypted IDLE PDUs will not be changed when they reach the destination. In accordance with an embodiment of the invention, to allow the receiving endpoint to properly identify the initiating endpoint when the initiator is behind a NAT/PAT router, the initiating endpoint in this example includes the OID_NAT_ROUTER option in the IDLE PDU that contains the NAT assigned public address or the PAT IP address as the source IP address and if applicable the PAT source port. SCIP IDLE PDUs use UDP port 51295 and are encapsulated using ESP encryption with IPSec transport mode.

SCIP IDLE handling is initiated by a Stealth enabled endpoint using the IDLE request PDU. The first IDLE request is sent after an initial timeout occurs and no incoming IDLE request has been received from the remote endpoint. If an IDLE request is received within the timeout period an IDLE reply is returned to the remote endpoint and the timer is reset for the initial timeout period.

In order to ensure that a remote endpoint uses the correct source port to return an IDLE PDU, the initial timeout for sending the IDLE request from a NAT/PAT endpoint may be 15 seconds, for example. This allows the NAT/PAT endpoint to send its first IDLE request to the remote endpoint and allows the remote endpoint to return the IDLE reply using the correct source port.

If the remote endpoint attempts to initiate an IDLE request without knowing the correct source port it will use the default SCIP IDLE source port 51295 and the IDLE PDU may be sent to the wrong PAT endpoint. This IDLE request PDU will their be ignored by the PAT endpoint currently using the SCIP IDLE source port because the Exchange ID of the IDLE PDU will not match the current Exchange ID being used by that endpoint. The error is logged in a local log file.

In one example, up to 3 IDLE request PDUs may be sent over a 70 second timeout period before the Stealth tunnel is terminated due to an IDLE SA failure. The first 2 IDLE requests in this example are sent at 30 second intervals and the last one is sent after a 5 second interval. The final 5 second interval with no IDLE reply results in the tunnel being closed.

The NAT Option is used in the IDLE PDU to pass the public IP address and, if applicable, the public port that the NAT/PAT router has mapped to the local (sending) endpoint so that the remote (receiving) endpoint can forward the IDLE to the correct Stealth tunnel for processing. Although IDLE PDUs are sent and received on port 51295, the public port used for all other PDU traffic (either 51294 or the PAT assigned port) is included in the NAT Option because this port as used in the criteria to create the Stealth tunnel when it was initialized. That port is, therefore, used to search for the Stealth tunnel for IDLE PDU processing. The NAT Option contains the port used by the PAT router in the mapping generated when SCIP tunnel initialization started. This allows the receiver of the IDLE PDU to create the correct search criteria in order to find the tunnel table entry for which this IDLE PDU is destined. IDLE PDU requests or responses from devices that have determined that they are behind a local PAT router may include a NAT Option. This is because the remote endpoint uses the original port in the search criteria. If the NAT Option is not present, the receiver uses the remote IP address on the port and the SCIP port 51294.

Endpoints that are not behind either a NAT router or a PAT router do not include a NAT Option in IDLE PDUs. An endpoint that receives an IDLE PDU without a NAT Option uses the normal search criteria to locate the correct Stealth tunnel by first searching for a legacy entry and then searching for a non-legacy entry, as in the flowchart 200 of FIG. 2. A table entry must exist in order to process an incoming IDLE.

Because PAT routers assign new source ports to each new destination port initiated from the PAT endpoint, SCIP PDUs and SCIP IDLE PDUs sent from a single PAT endpoint use different, source ports. In order to direct the IDLE traffic to the correct Stealth tunnel on the receiver, the source port assigned by the PAT router during tunnel initiation is included in the NAT Option so that it can be used to search for the correct Stealth tunnel on the receiver. If the NAT Option is found on an inbound IDLE PDU, the receiver uses the source port and source IP address in the NAT Option as search criteria to search for a table entry for the Stealth tunnel for which the IDLE PDU is destined.

Because IDLE PDUs are sent via a previously created IPSec tunnel, the original IP header used to send the IDLE PDU is unchanged when the data is decrypted by the receiving endpoint. The original IP header contains the private IP address and the original source port (51295) of the data received by the source port. In this example, in order to identify the appropriate Stealth tunnel, the public IP address and, where applicable, the PAT source port, need to be known by the receiving endpoint.

When using IPSec transport mode the original IP header of the message is not encrypted in the ESP frame, but the transport layer header (i.e. UDP) is encrypted. In addition, when using IPSec transport mode with NAT-Traversal (NAT-T), IPsec adds an additional UDP header using IPSec port 4500 in order to traverse the NAT/PAT router. This is done to allow a PAT router to successfully map and modify the IP address and port as needed for PAT traversal. As the encrypted IDLE PDU passes through the PAT router, the IP header and IPSec NAT-T UDP header are modified, but once the IDLE PDU is decrypted at the receiver only the IP source address has been changed in the original IP header. The UDP header with port 51295 is not changed because it is encrypted when it passes through the PAT router.

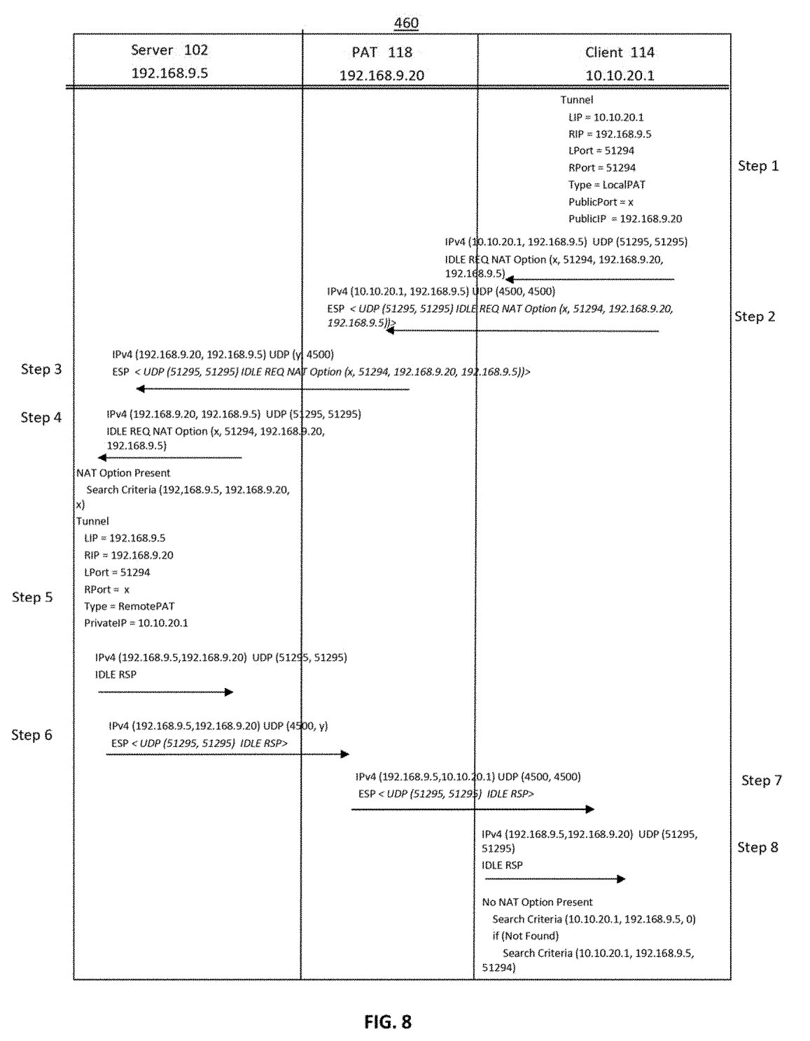

FIG. 8 is a flow diagram 460 of an example of the exchange of IDLE PDUs from a PAT endpoint, here the client 114, though the PAT router 118, to a public endpoint, here the server 102. In this example, the client 114 has the same Stealth tunnel table entry as in Step 5 of FIG. 7, because the tunnel was previously established in FIG. 7. The client 114 sends an IDLE request message to server 204 through the PAT router 118, in Step 1 of FIG. 8. The IDLE Request message in this example has the form: IPv4 (10.10.20.1, 192.168.9.5) UDP (51295, 51295), IDLE REQ NAT Option (x, 51294, 192.168.9.20, 192.168.9.5). Since the client 114 is aware of the presence of the PAT router 118 from FIG. 6, the IP address of the PAT router 118 is identified in the IP header and in the NAT Option of the IDLE request As discussed above, the local port of the client 114 and the receiving port of the PAT router 118 are both 51295, which is identified in the UDP. Even though the IDLE PDU is sent and received on the 51295 ports, the port x of the PAT router 118, the IP address of the PAT router, and the IP address of the server 102 are provided in the NAT Option so that the server 102 can search for the appropriate table entry.

In Step 2, the payload of the message generated in Step 1 is encrypted by the client 114. During encryption, the ESP traffic portion is encapsulated with an additional UDP header. The partially ESP encrypted message has the form: IPv4 (10.10.20.1, 192.168.9.5) UDP (4500, 4500) ESP <UDP (51295, 51295) IDLE REQ NAT Option (x, 51294, 192.168.9.20, 192.168.9.5)>. The partially encrypted message is sent to the PAT router 118.

In Step 3, the PAT router 118 changes the UDP outside the encrypted portion of the PDU to UDP (4500, 4500), as it traverses the PAT router 118 in accordance with the NAT-T RFC standard. The encrypted portion of the message, the inner IDLE PDU, transfers information regarding the PAT endpoint (client 114) so that the correct Stealth tunnel can be located to process the IDLE PDU on the receiving side. The encrypted payload of the message is not changed, while the unencrypted portion of the message is changed from the original IDLE PDU generated by the client 114.

Then, the PAT router 118 modifies IP header, which is not encrypted, to replace the IP address of the client 208 by its own IP address and to change the sending port from 4500 to y, in Step 3.

The server 102 receives the message in Step 3, stores the NAT Option information, searches the table with the legacy search criteria, and then the non-legacy search criteria to find the appropriate tunnel entry, in Step 5. The tunnel entry is located based on the non-legacy search criteria. The information stored by the server 102 in its table is the same as that in Step 7 of FIG. 6. The server 102 generates the following Idle Response: IPv4 (192.168.9.5, 192.168.9.20) UDP (51295, 51295) Idle RSP. The message is encrypted by the server 102 in Step 6, resulting in the message IPv4 (192.188.9.5, 192.168.4.20) (UDP (4500, y) ESP <UDP (51295, 51295) IDLE RSP>, which is sent to the PAT router 118. As discussed above, a NAT Option is not included because the server 102 is not behind a local PAT router.

The PAT router 118 receives the Idle Response, in Step 6. The PAT router 118 changes the destination IP address from its own IP address to the IP address of the client 114, and changes the destination port from its own destination port to 4500. The encrypted portion of the message is not changed. The resulting message is: IPv4 (192.168.9.5, 192.10.10.20.1) UDP (4500, 4500) ESP<UDP (51295, 51295) Idle RSP>.

The client 114 receives and decrypts the Idle Response resulting in: IPv4 (192.168.9.5, 192.168.9.20) UDP (51295, 51295), IDLE RSP, in Step 8. The client 114 uses the search criteria (LIP, RIP, 0) to search its table and if a tunnel entry is not found, it uses the search criteria (LIP, RIP, 51294). If a table entry is found, the client verifies that the originally initiated tunnel is still open. SCIP IDLE PDUs are sent periodically during the life of the tunnel to determine if the underlying IPSec communications have been terminated unexpectedly, and when.

### SCIP Keep Alive Exchange

Certain behaviors of PAT routers, such as the PAT router 118, may result in a source port used to initially open a Stealth tunnel from one endpoint behind a PAT router, such as the client 114, being reused by a second Stealth tunnel from a different PAT endpoint, such as the client 116 in FIG. 1. In one example, the PAT router 118 may use the original source port to identify an endpoint the first time an attempt is made to reach a specific destination port. Because of this, the first Stealth tunnel to open through a PAT router will use the SCIP (51294) source port for Stealth tunnel establishment and the first IPSec connection will use the 4500 source port. Keep Alive IPSec packets used for NAT/PAT traversal keep the port 4500 alive, but the port 51294 will eventually timeout and may be reused by the PAT router 116 as the source port for another Stealth endpoint behind that PAT router.

When the PAT router 118 reuses the SCIP source port several problems may occur. First, if the SCIP source port is used by a second PAT endpoint for tunnel initialization, the original PAT endpoint that used this source port, will receive the Sess0 PDU from the second PAT end point and will terminate. Second, if the SCIP port is used to terminate a Stealth tunnel, the TERM PDU may be received by the wrong Stealth tunnel at the receiver and will result in that tunnel being terminated.

If the mapped port used to establish the Stealth tunnel during tunnel initiation, were to time out and be reused for another type of communication in the mapped table of the PAT router 118, the TERM PDU would be assigned a different mapped port by the PAT router. If that happened, there would be no way for that TERM PDU to be routed to the correct table entry by the receiving endpoint. As a result, the remote tunnel would not be cleaned up properly. The validation and encryption keys are exchanged during S0, S1, and S2 exchange as is known in the art.

In accordance with an embodiment of the invention, a new Session 6 PDU is used in order to keep a Stealth tunnel active across a PAT router. In the example, the Sess6 PDU has the following format:
Sess.6::=UDP(<CTPort>, ̂U.VAL:8:96, (IV:8*16, (SCIPHeader, SessionInfo)*U.ENC))

U. Val means that the following fields in the PDU are signed using the validation key. *U.ENC means that previous fields within the parentheses ( ) are encrypted using the encryption key.

In this example, Sess6 PDUs are encrypted and signed using the Stealth tunnel session keys, as is known in the art. All NAT/PAT endpoints send Sess6 PDUs periodically, such as every 20 seconds, for example. Other amounts of time may be provided and the amount of time may be set by a system administrator, for example. In addition, all endpoints may process inbound Sess6 PDUs (they may flow in both directions if the tunnel has more than one NAT/PAT router). A failure to decrypt a Sess6 PDU may result in the tunnel being terminated due to an invalid Session PDU error.

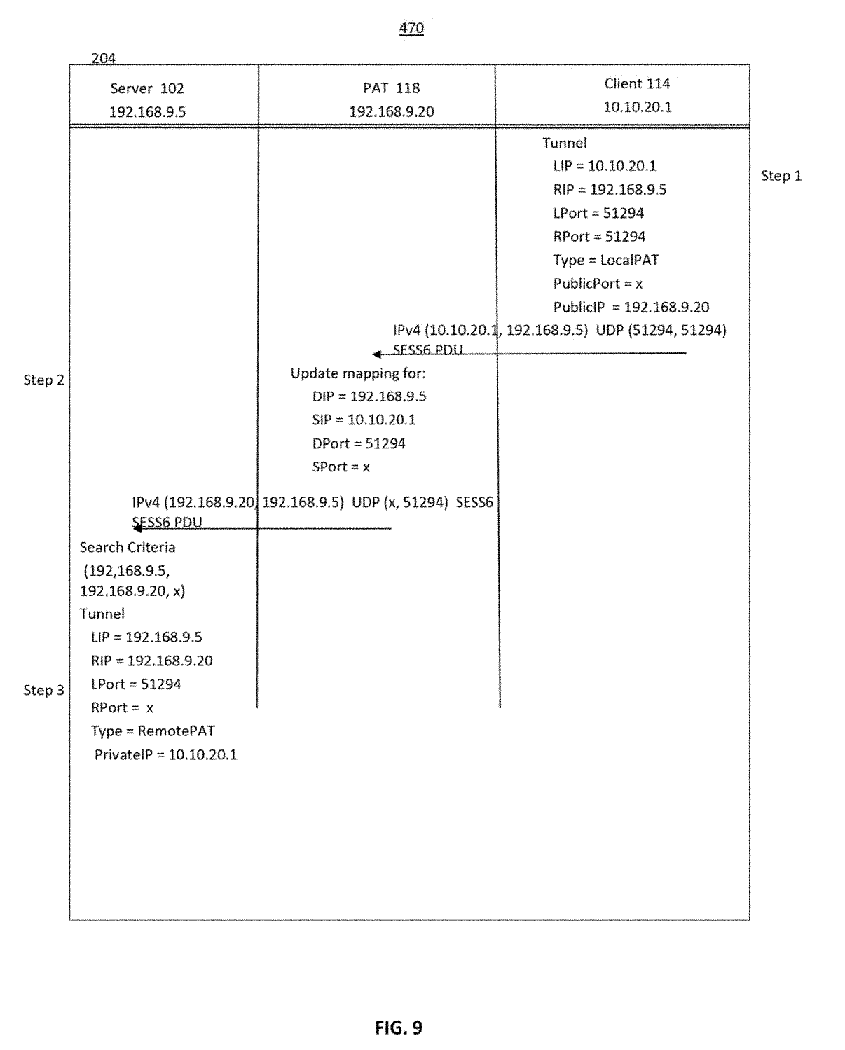

FIG. 9 is allow diagram of an example 470 of the exchange of Sess6 Keep Alive PDUs from the PAT endpoint (the client 114) to the public endpoint (the server 102), to keep open a Stealth tunnel. In Step 1 of FIG. 9, the Stealth tunnel information stored by the client 114 is the same as that in Step 5 FIG. 6, where the Stealth tunnel was completed. The client 114 generates and sends a Session 6 (“Sess6”) PDU to the server 102 in Step 1 in the form: IPv4 (10.10.20.1, 192.168.9.5) UDP (51294, 51294) SESS6 PDU. The Sess6 PDU portion of the message is shown above.

The PAT router 118 replaces its own IP address and mapped source port for that of the client 114 in the IP header and forwards the following updated Sess6 PDU to the server 102, in Step 2: IPv4 (192.168.9.20, 192.1689.5) UPD (51294, 94) Sess0 PDU. The mapping in the PAT router 118 for this tunnel is marked as being in use, so that this source port will not be used for another mapping for another Stealth tunnel or other traffic. The PAT router 118 keeps the PAT mapping of its source port to the private IP address of the PAT endpoint (the client 208). This mapping is established when the S0 PDU is first sent from the client 208 through the PAT router 118, in FIG. 6.

In Step 3, the server 102 receives the message, uses search criteria (LIP, RIP, 51294) of the Sess6 PDU, and keeps the Stealth tunnel active across the PAT router 118. The server 102 is shown storing the same Stealth tunnel information as in Step 7 of FIG. 6.

### PAT Endpoint to NAT Endpoint

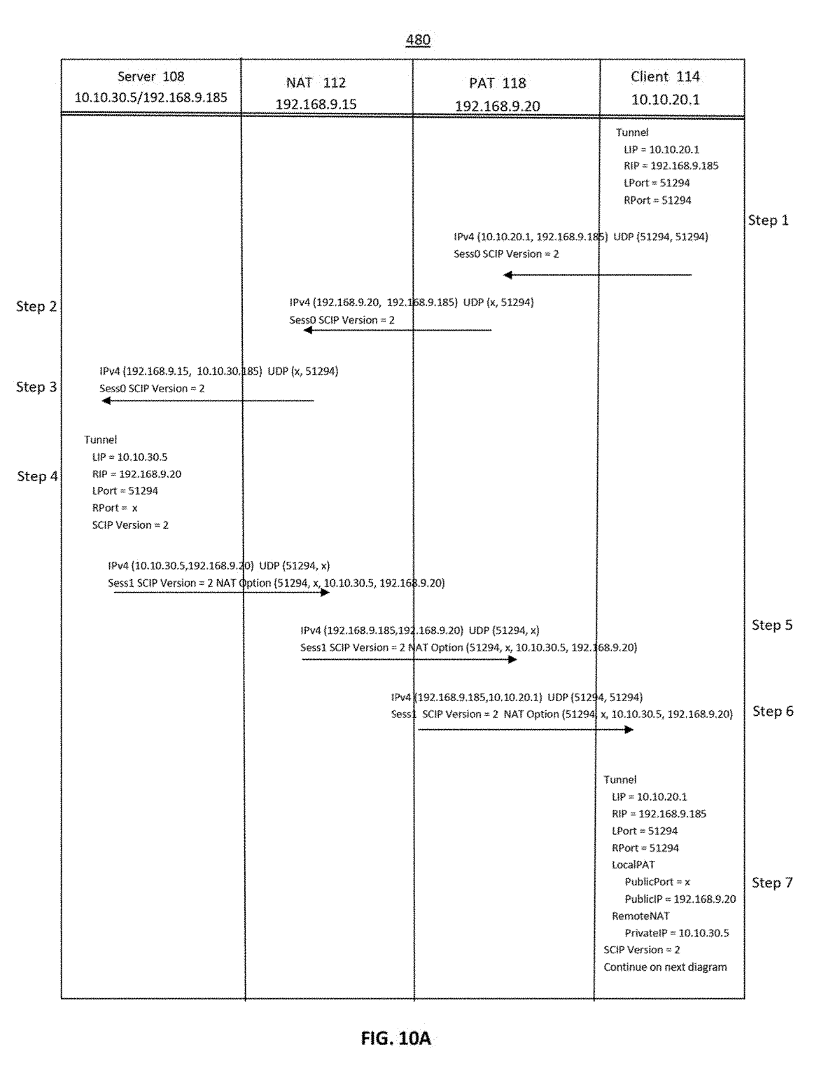

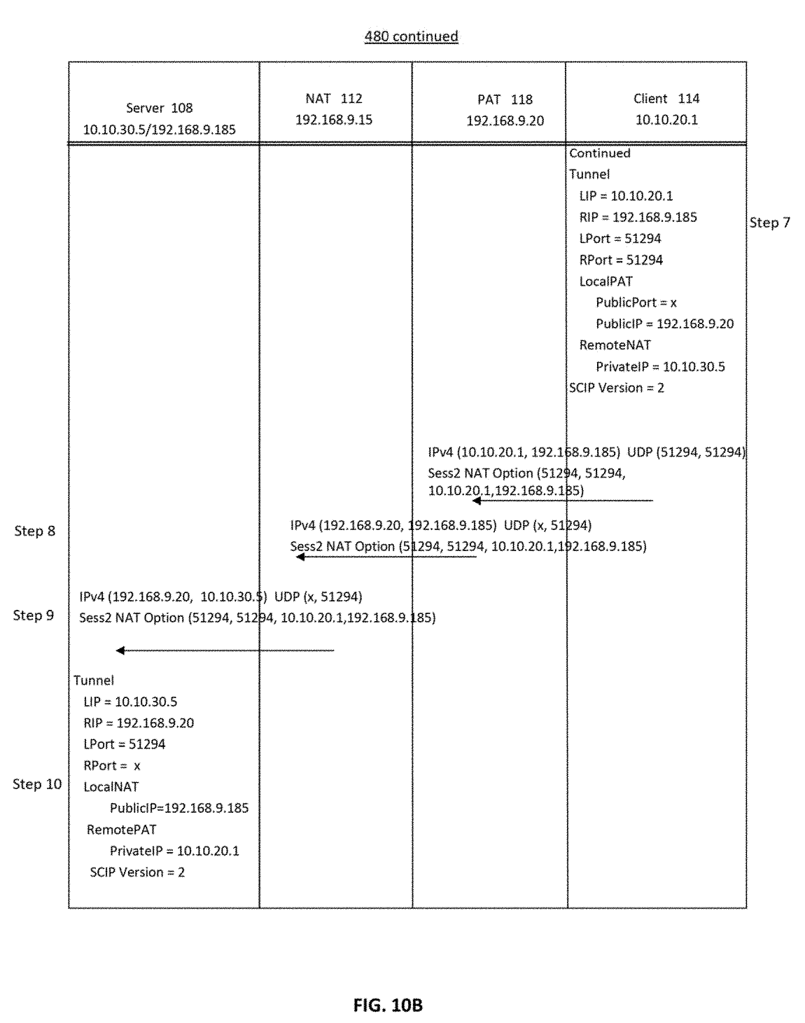

FIG. 10A and FIG. 10B are portions of a flow diagram 480 of an example of SCIP exchange initiated from the PAT endpoint (the client 114) to an endpoint (the server 108) behind a NAT router 112 using the public address assigned by the NAT router to the NAT endpoint, as in FIG. 1. In this example, the tunnel is initiated by the client 114 to the server 108. FIG. 10A also shows the private address of the server 108 (10.10.30.5).

As above, tunnel initialization begins from the client 114 behind the PAT router 118 because the PAT router must dynamically establish a mapping of the client's private IP address to its own public IP address and a mapped source port. This mapping allows the PAT router 118 to properly direct traffic from the Public endpoint (of the server 108) back to the correct PAT endpoint (the client 114). As is known in the art, NAT 1:1 routers, such the NAT router 112, are configured with static mappings of each private IP address to a public IP address, unlike PAT routers. For this reason, SCIP tunnel initialization may be initiated either inbound or outbound to NAT endpoints via a public IP address.

FIG. 10A shows a first phase of tunnel initiation. FIG. 10B shows a second phase. Phase 1 begins in Step 1, with tunnel initialization at the client 114 by creating a tunnel entry with the local private IP address (LIP=10.10.20.1), remote IP address of the server 108 (RIP=192.168.9.285), local port of the client (LPort=51294), and remote port of the server (RPort=51294). The client 114 S0 PDU generates and sends S0 PDU having the form: IPv4 (10.10.20.1, 192.168.9.5) UDP (51294, 51294), Sess0 SCIP Version=2.

The PAT router 118 modifies the IP header of the received message, replacing the private source IP address 10.10.20.1 with its own public IP address 192.169.9.20 and replacing the source port with its mapped source port x, as above. The resulting message is IPv4 (192.168.9.20, 192.168.9.5) UDP (x, 51294) Sess0 SCIP Version=2, which is sent to the NAT 112 in Step 2.

The NAT router 112 receives the message from the PAT router 118, and modifies the IP header by replacing the destination IP address of the server 108 (192.168.9.5) with the private IP address of the server (10.10.30.5), in Step 3. The NAT router 112 also changes the source IP address of the PAT router 118 to its own IP address (192.168.9.15). The resulting message is sent to the server 108. The message has the form: IPv4 (192.168.9.15, 10.10.305) UDP (x, 51294) Sess0 SCIP Version=2.

The server 108 creates a Sess1 PDU using its local IP address (10.10.30.5) and the source address of the PAT router 206 (192.168.9.20), and saves the source port x in the tunnel table entry, along with the LIP, RIP, and LPort from the received Sess0 PDU. SCIP Version=2 is also stored. The server 108 then sends the Sess1 PDU to the client using the PAT router 118 public address as the destination IP address and the mapped port x the destination port. The server includes a NAT Option in the Sess1 PDU with the source port, destination port, source IP address and destination IP address. The Sess1 PDU is: IPv4 (10.10.30.5, 192.168.9.20) UDP (51294, x), Sess 1 SCIP Version=2 NAT Option (51294, x, 10.10.30.5, 192.168.9.20).

The NAT router 112 receives the message in Step 5 and modifies the IP header of the message by replacing the private server IP address of the server 108 with the public IP address mapped to this NAT endpoint (192.168.9.185). The NAT router 112 sends the following resulting message to the PAT router 118: IPv4 (192.168.9.185, 192.168.9.20) UDP (51294, x) Sess 1 SCIP Version=2 NAT option (51294, x, 10.10.30.5, 192.168.9.20). As with the PAT router 118, the NAT router 112 does not change the information in the NAT Option.

The PAT router 118 receives the message from the NAT router 112 in Step 6, and modifies the IP header, replacing the destination IP address and destination port to the original PAT endpoint IP address of the client 208 (10.10.20.1) and port of the client (51294). The resulting message that is sent to the client 208 is: IPv4 (192.168.185.5, 10.10.20.1) UDP (51294, 51294) Sess 1 SCIP=2 NAT Option (51294, x, 10.10.30.5, 192.168.9.20).

Since there is an NAT Option in the received Sess1 PDU (Yes in Step 304 of FIG. 3), the client 114 determines whether the source IP address in the NAT Option (SIP=10.10.30.5) is the same as the remote IP address in the table entry (RIP=192.168.9.185). Since they do not match, the client 114 determines whether the source port in the NAT Option (Sport=51294) matches the remote port in the table entry (RPort=51294), in Step 310 of FIG. 3. Since they do match, the client 114 determines that remote endpoint (the server 108) is behind a NAT router (the NAT router 112), and the private IP address of the server is 10.10.30.5. The tunnel entry is updated to reflect these determinations, as shown in Step 7 of FIG. 10A.

The client 114 further determines whether the local IP address in the table entry (LIP=10.10.20.1) is the same as the destination IP address in the NAT Option (DIP=192.168.920), as in Step 316 of FIG. 3. Since they do not match, the client determines that it is behind a local PAT router (the PAT router 118), having a public port (PublicPort) equal to x and an IP address (PublicIP) of 192.168.9.20. The tunnel entry is updated to reflect these determinations, as shown in Step 8 of FIG. 10A.

In Phase 2 of the flow diagram 480 process shown in FIG. 10B, the client 114 generates and returns an S2 PDU that includes the NAT Option with the source port, destination port, source IP address and destination IP address in a message having the form: IPv4 (10.10.20.1, 192.168.9.185) UPD (51294, 51294), Sess 2 NAT Option (51294, 51294, 10.10.20.1, 192.168.9.185), in Step 7.

The PAT router 118 receives the S2 PDU and modifies the IP header, replacing the IP address and destination port with its own, in Step 9. The resulting message is: IPv4 (192.168.9.20, 192.168.9.185) UDP (x, 51294), Sess 2 NAT Option (51294, 41294, 10.10.20.1, 192.168.9.185). The resulting message is sent to the server 108, through the NAT router 112.

The NAT router 112 receives the message from the PAT router 118, in Step 8, and modifies the IP header by replacing the public IP address of the server 108 with the private IP address of the server. The resulting message is: IPv4 (192.168.9.20, 10.10.30.5) UDP (x, 51294), Sess 2 NAT option (51924, 51294, 10.10.20.1, 192.168.9.185), which is sent to the server 108 in Step 9.

The server 108 processes the S2 PDU, and identifies that an NAT Option is present, as in Step 304 of FIG. 3. The server 108 then determines whether the source IP address in the NAT Option (SIP=10.10.20.1) is the same as the remote IP address in the table entry (RIP=192.168.9.20). Since they do not match, the server 108 determines whether the source port in the NAT Option (Sport=51294) matches the remote port in the table entry (RPort=x), as in Step 310 of FIG. 3. Since they do not match, the server 108 determines that the remote endpoint (the client 114) is behind a PAT router (the PAT router 118), and the private IP address of the client 114 is 10.10.20.1 The tunnel entry is updated to reflect these determinations, as shown in Step 10 of FIG. 10B.

The server 108 further determines whether the local IP address in the table entry (LIP=10.10.30.5) is the same as the destination IP address in the NAT Option (DIP=192.168.9.185), as in Step 316 of FIG. 3. Since they do not match, the server 108 determines whether the destination port in the NAT Option (51294) is the same as the local IP port (LIP=51294), as in Step 318 of FIG. 3. Since they match, the server 108 determines that it is behind local NAT router (the NAT router 112) having a public IP address (PublicIP=192.168.9.15). The server updates the table entry with these determinations, as shown in Step 10 of FIG. 10B.

### IKE and IPsec Protocol

IPSec tunnel mode discussed above is the default mode of communication used when SCIP negotiation is complete and the local and remote endpoints have determined that there are no NAT or PAT routers in the data path. In order to support NAT/PAT traversal, both endpoints generate IKE and IPSec policies that allow IKE to initiate NAT/PAT traversal. Once Stealth SCIP negotiation has completed successfully, the Stealth software dynamically sets up policies to allow the two endpoints to communicate over IPSec. This allows all traffic between the endpoints to be fully authenticated and encrypted with the standard IPSec protocol. The IPSec communications are terminated when the Stealth tunnel closes.

For both NAT and PAT traversal both the initiating endpoint and the responding endpoint detect that there are one or more NAT routers and/or PAT router in the data path. This discovery through the SCIP PDU exchange results in the endpoints using IPSec Transport Mode policies for communication, in subsequent communications. The policies on the local endpoint are generated so that both Main Mode and Quick Mode negotiation can be initiated for the combined remote public and private addresses resulting in NAT/PAT discovery.

### IKE and IPSec Negotiation

SCIP negotiation is used to negotiate an IKE and IPSec cryptographic profile for communication between two endpoints. The crypto.xml installed with the endpoint package contains the profiles that the endpoint should support. During tunnel initiation the initiator includes a bit mask of all supported profiles in the crypto.xml. The responder uses the bit mask to determine if it has a matching profile and returns in the S1 PDU the highest bit that matches its supported profiles. The initiator and responder then use this profile for IKE and IPSec communications.

To support communication to multiple PAT endpoints as in FIGS. 10A and 10B, for example, new profiles are created that include use of X509 certificates for IKE negotiation. This is required because pre-shared keys with IKE version 1 do not work properly with multiple PAT endpoints. The current crypto XML contains two profiles that match in all aspects except that one uses pre-shared keys (0x1) and the other uses X509v3 certificates (0x80) for IKEv1 negotiation. In order to support X509v3 certificates with IKEv1 for PAT endpoints the profile that uses certificates is added to the default profile list for all Windows and Linux endpoint profiles. In addition, the crypto XML version is increased to version “3”.

### SCIP Version 2 Crypto Negotiation

Profile negotiation is used to determine the attributes used for IKE and IPSec communications between two endpoints. In order to support the use of X509 certificates for IKE authentication, the TopSecret-IKEv1-DH20-X509v3 profile (0x80) is added to the list of default profiles. In addition, endpoints that support NAT/PAT and the new profile use SCIP Version 2 during negotiation.

When the initiator sends the S0 PDU, the profile mask includes bits 0x01, 0x04 and 0x80 and the SCIP Version equals 2. The responding endpoint checks the bit mask against its own profile list and returns its supported profile(s). Endpoints that support SCIP version 2 in their supported profiles include profile 0x80 and check the remote port. If the remote port is not the Stealth SCIP port (51294), this indicates that the remote port is behind a PAT router. In this case, the endpoint overrides the normal profile negotiation and returns the X509v3 (0x80) profile.

Endpoints that do not support SCIP version 2 (legacy endpoints) will return a single the negotiated matching profile bit in the S1 PDU mask. (i.e. 0x01 or 0x04 for AIX).

Upon processing of the S1 PDU, normal processing occurs. If the S1 PDU indicates the X509v3 (0x80) profile, the endpoint uses X509v3 ( 0x80) for IKE and IP Sec communications to the remote PAT endpoint. The initiator will return the NAT option in the S2 PDU. Once the responder has processed the S2 PDU, it will be the appropriate profile for communications.

In this way, IPSec negotiation and NAT/PAT negotiation work together to determine the profile used for IPSec communication between the two endpoints.

### IKE Certificate Creation and Identification

When a crypto profile that uses X509v3 certificates for IKE negotiation is used for Stealth communications to a PAT endpoint the endpoints identify a valid X509v3 certificate available in the certificate store on the endpoint. Certificates that are valid for use during Stealth IKE negotiation will be identified in the certificate store using a new Object Identifier (“OID”) in the Extended Key Usage (“EKU”) of the certificate. An OID is a string of numbers separated by periods which is used to identify and validate the certificate use. Unisys has OIDs which identify an object for use by Unisys software including OIDs for Certificate Base Authorization with both machine and user certificates. A new OID is defined for use with Stealth IKEv1 negotiation. The Unisys supplied OIDs have the following format:

Enterprise Unisys: 1.3.6.1.4.1.223.
Stealth: 52.
   CBA: 1.
      Computer certificate: 1. User Certificate: 2
   IKE: 2.
      IKEv1: 1. IKEv2: 2

Using this format, the Unisys supplied OID are as follows:
Unisys Stealth CBA machine certificate is 1.3.6.1.4.1.223.52.1.1
Unisys Stealth CBA user certificate is 1.3.6.1.4.1.223.52.1.2.
Unisys Stealth IKEv1 machine certificate is 1.3.6.1.4.1.223.52.2.1
Unisys Stealth IKEv2 machine certificate is 1.3.6.1.4.1.223.52.2.2

The enterprise can create certificates in any way desired. Typical scenarios include: 1) auto enrollment, in which the client adds the Option ID (“OID”) to the template; 2) manual creation using an enterprise Certification Authority (“CA”), in which the client includes the OID in the parameters used to create the certificate; and 3) commercial CA, in which the client supplies the OID to the CA creating the certificate, for example.

FIG. 11 is a block diagram of an example of a processing device 500 that could serve as a server or a client in FIG. 1. A central processing unit (“CPU”) or processor 502 is coupled to the system bus 804. The CPU 502 may be a general purpose CPU or microprocessor, graphics processing unit (“GPU”), and/or microcontroller, for example. The present embodiments are not restricted by the architecture of the CPU 502 so long as the CPU 502, whether directly or indirectly, supports the operations as described herein. The CPU 502 may execute the various logical instructions as described herein.

The processing device 500 also may include random access memory (RAM) 508, which may be synchronous RAM (SRAM), dynamic RAM (DRAM), synchronous dynamic RAM (SDRAM), or the like. The processing device 500 may use RAM 508 to store the various data structures used by a software application. The processing device 500 may also include read only memory (ROM) 506, which be PROM, EPROM, EEPROM, optical storage, or the like. The ROM may store configuration information for booting the processing device 500. The RAM 508 and the ROM 506 hold user and system data, and both the RAM 508 and the ROM 506 may be randomly accessed.

The processing device 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the processing device 500. The display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the processing device 500. In one example, the data storage 512 may be a separate server coupled to the processing device 500, through a network connection to the 110 adapter 510. The communications adapter 514 may be adapted to couple the processing device 500 to the network 508, which corresponds to the network 106 in FIG. 1. As discussed above, the network 508 may be one or more of a LAN, WAN, and/or the Internet, for example. The user interface adapter 516 couples user input devices, such as a keyboard 520, a pointing device 518, and/or a touch screen (not shown) to the processing device 500. The keyboard 520 may be an on-screen keyboard displayed on a touch panel. The display adapter 522 may be driven by the CPU 502 to control the display on the display device 524. Any of the devices 502-522 may be physical and/or logical.

The applications of the present disclosure are not limited to the architecture of the processing device 500. Rather the processing device 500 is provided as an example of one type of processing device that may be adapted to perform the functions of the servers of FIG. 1. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the processing device 500 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to, the present disclosure. Accordingly, the appended claims are intended to include within their scope such processes, machines, manufacture, compositions of matter, means, methods, or steps.

We claim:

1. A method of communicatively connecting a first endpoint to a second endpoint to form an IPSec encrypted tunnel, wherein at least one of the endpoints is behind a PAT or NAT router, the method comprising:
receiving a message by the first endpoint from the second endpoint, the message including an encrypted portion including a source port, a destination port, a source IP address, and a destination IP address;
determining whether a table entry exists for the message;
if the table entry exists, determining by the first endpoint whether a NAT router and/or a PAT router is between the first endpoint and the second endpoint based, at least in part, on the table entry and the encrypted portion of the message; and
creating an IPSec encrypted tunnel using IPSec transport mode for further communications between the first endpoint and the second endpoint, if a NAT router and/or a PAT router is determined to be between the first endpoint and the second endpoint.

2. The method of claim 1, comprising determining that the first endpoint is behind a local PAT router or a local NAT routers by:
comparing the local IP address in the table entry with the destination IP address in the encrypted portion of the first message;
if the local IP address in the table entry and the destination IP address in the encrypted portion of the first message are different, comparing the local port in the table entry with the destination port in the encrypted portion of the first message;
if the local port in the table entry matches the destination port in the encrypted portion of the first message, determining that the first endpoint is behind a local NAT router, and
if the local port in the table entry does not match the destination port in the encrypted portion of the first message, determining that the first endpoint is behind a local PAT router.

3. The method of claim 1, comprising determining that the second endpoint is behind a remote PAT router or a remote NAT router by:
determining whether the remote IP address in the table entry matches the source IP address in the encrypted portion of the first message;
if the remote IP address in the table entry does not match the source IP address in the encrypted portion of the first message, determining whether the remote port in the table entry matches the source port in the encrypted portion of the first message; and
if the remote port in the table entry matches the source port in the encrypted portion of the first message, determining that the second endpoint is behind a remote NAT router, or
if the remote port in the table entry does not match the source port in the encrypted portion of the first message, determining that the second endpoint is behind a remote PAT router.

4. The method of claim 1, comprising creating the table entry comprising the local IP address of the first endpoint, the local port of the first endpoint, the remote IP address of the second endpoint, and the remote port of the second endpoint.

5. The method of claim 1, wherein:
the first message is a SCIP message;
the first endpoint and the second endpoint use a version of SCIP capable of including the encrypted portion of the first message; and/or
the source port of the first endpoint and the source port of the second endpoint are SCIP ports.

6. The method of claim 5, further comprising:
if the first endpoint is behind a PAT router or a NAT router, sending a first SCIP encrypted message inside an IPSec encrypted tunnel by the first endpoint to the second endpoint to verify that IPSec communications between the first endpoint and the second endpoint are active,
wherein the first SCIP encrypted message includes a publicIP address assigned to the second endpoint by a NAT router, or an IP address of a PAT router and/or a port number of the PAT router; and
receiving from the second endpoint a second SCIP encrypted message inside the IPSec encrypted tunnel to verify that IPSec communications between the first endpoint and the second endpoint are active;
wherein the first encrypted message is sent before the second encrypted message.

7. The method of claim 5, further comprising:
periodically sending a SCIP encrypted message from the first endpoint to the second endpoint to keep the NAT and/or PAT mapping active.

8. An apparatus, comprising:
a memory; and
a processor coupled to the memory, wherein the processor is configured to perform the steps of:
receiving a message by the first endpoint from the second endpoint, the message including an encrypted portion including a source port, a destination port, a source IP address, and a destination IP address;
determining whether a table entry exists for the message;
if the table entry exists, determining by the first endpoint whether a NAT router and/or a PAT router is between the first endpoint and the second endpoint based, at least in part, on the table entry and the encrypted portion of the message; and
creating an IPSec encrypted tunnel using IPSec transport mode for further communications between the first endpoint and the second endpoint if a NAT router and/or a PAT router is determined to be between the first endpoint and the second endpoint.

9. The apparatus of claim 8, wherein the processor is further configured to perform the steps of:
determining that the first endpoint is behind a local PAT router or a local NAT routers by:
comparing the local IP address in the table entry with the destination IP address in the encrypted portion of the first message;
if the local IP address in the table entry and the destination IP address in the encrypted portion of the first message are different, comparing the local port in the table entry with the destination port in the encrypted portion of the first message;
if the local port in the table entry matches the destination port in the encrypted portion of the first, message, determining that the first endpoint is behind a local NAT router, and
if the local port in the table entry does not match the destination port in the encrypted portion of the first message, determining that the first endpoint is behind a local PAT router.

10. The apparatus of claim 8, wherein the processor is further configured to perform the steps of:
determining that the second endpoint is behind a remote PAT router or a remote NAT router by:
determining whether the remote IP address in the table entry matches the source IP address in the encrypted portion of the first message;
if the remote IP address in the table entry does not match the source IP address in the encrypted portion of the first message, determining whether the remote port in the table entry matches the source port in the encrypted portion of the first message; and
if the remote port in the table entry matches the source port in the encrypted portion of the first message, determining that the second endpoint is behind a remote NAT router, or
if the remote port in the table entry does not match the source port in the encrypted portion of the first message, determining that the second endpoint is behind a remote PAT router.

11. The apparatus of claim 8, wherein the processor is further configured to perform the steps of:
creating the table entry comprising the local IP address of the first endpoint, the local port of the first endpoint, the remote IP address of the second endpoint, and the remote port of the second endpoint.

12. The apparatus of claim 8, wherein:
the first message is a SCIP message;
the first endpoint and the second endpoint use a version of SCIP capable of including the encrypted portion of the first message; and/or
the source port of the first endpoint and the source port of the second endpoint are SCIP ports.

13. The apparatus of claim 12, wherein the processor is further configured to perform the steps of:
sending a first SCIP encrypted message inside an IPSec encrypted tunnel by the first endpoint to the second endpoint to verify that IPSec communications between the first endpoint and the second endpoint are active,
wherein the first SCIP encrypted message includes a public IP address assigned to the second endpoint by a NAT router, or an IP address of a PAT router and/or a port number of the PAT router; and
receiving from the second endpoint a second SCIP encrypted message inside the IPSec encrypted tunnel to verify that IPSec communications between the first endpoint and the second endpoint are active;
wherein the first encrypted message is sent before the second encrypted message.

14. The apparatus of claim 12, wherein the processor is further configured to perform the steps of:
periodically sending a SCIP encrypted message from the first endpoint to the second endpoint to keep the NAT and/or PAT mapping active.

15. A computer program product, comprising:
a non-transitory computer readable medium comprising instructions which, when executed by a processor of a computer system, cause the processor to perform the steps of:
receiving a message by the first endpoint from the second endpoint, the message including an encrypted portion including a source port, a destination port, a source IP address, and a destination IP address;
determining whether a table entry exists for the message;
if the table entry exists, determining by the first endpoint whether a NAT router and/or a PAT router is between the first endpoint and the second endpoint based, at least in part, on the table entry and the encrypted portion of the message; and
creating an IPSec encrypted tunnel using IPSec transport mode for further communications between the first endpoint and the second endpoint if a NAT router and/or a PAT router is determined to be between the first endpoint and the second endpoint.

16. The computer program product of claim 15, wherein the medium further comprises instructions which cause the processor to perform the steps of:
determining that the first endpoint is behind a local PAT router or a local NAT routers by:
comparing the local IP address in the table entry with the destination IP address in the encrypted portion of the first message;
if the local IP address in the table entry and the destination IP address in the encrypted portion of the first message are different, comparing the local port in the table entry with the destination port in the encrypted portion of the first message;
if the local port in the table entry matches the destination port in the encrypted portion of the first message, determining that the first endpoint is behind a local NAT router, and
if the local port in the table entry does not match the destination port in the encrypted portion of the first message, determining that the first endpoint is behind a local PAT router.

17. The computer program product of claim 15, wherein the medium further comprises instructions which cause the processor to perform the steps of:
determining that the second endpoint is behind a remote PAT router or a remote NAT router by:
determining whether the remote IP address in the table entry matches the source IP address in the encrypted portion of the first message;
if the remote IP address in the table entry does not match the source IP address in the encrypted portion of the first message, determining whether the remote port in the table entry matches the source port in the encrypted portion of the first message; and
if the remote port in the table entry matches the source port in the encrypted portion of the first message, determining that the second endpoint is behind a remote NAT router, or
if the remote port in the table entry does not match the source port in the encrypted portion of the first message, determining that the second endpoint is behind a remote PAT router.

18. The computer program product of claim 15 wherein the medium further comprises instructions which cause the processor to perform the steps of:
creating the table entry comprising the local IP address of the first endpoint, the local port of the first endpoint, the remote IP address of the second endpoint, and the remote port of the second endpoint.

19. The computer program product of claim 15, wherein:
the first message is a SCIP message;
the first endpoint and the second endpoint use a version of SCIP capable of including the encrypted portion of the first message; and/or
the source port of the first endpoint and the source port of the second endpoint are SCIP ports.

20. The computer program product of claim 19, wherein the medium further comprises instructions which cause the processor to perform the setups of:
sending a first SCIP encrypted message inside an IPSec encrypted tunnel by the first endpoint to the second endpoint to verify that IPSec communications between the first endpoint and the second endpoint are active,
wherein the first SCIP encrypted message includes a public IP address assigned to the second endpoint by a NAT router, or an IP address of a PAT router and/or a port number of the PAT router; and
receiving from the second endpoint a second SCIP encrypted message inside the IPSec encrypted tunnel to verify that IPSec communications between the first endpoint and the second endpoint are active;
wherein the first encrypted message is sent before the second encrypted message.

21. The computer program product of claim 19, wherein the medium further comprises instructions which cause the processor to perform the steps of:
periodically sending a SCIP encrypted message from the first endpoint to the second endpoint to keep the NAT and/or PAT mapping active.
